(19) United States
(12) Patent Application Publication
(10) Pub. No.: US 2019/0095077 A1
(43) Pub. Date: Mar. 28, 2019

(54) ELECTRONIC APPARATUS

(71) Applicant: KYOCERA CORPORATION, Kyoto (JP)

(72) Inventors: Takahiro MORI, Yokohama-shi (JP); Mayu SANDA, Osaka (JP); Kousuke TERUYAMA, Yokohama-shi (JP); Tomohiro SHIMAZU, Yokohama-shi, (JP); Taro FUKASAWA, Kawasaki-shi (JP)

(21) Appl. No.: 16/141,754

(22) Filed: Sep. 25, 2018

(30) Foreign Application Priority Data
Sep. 27, 2017 (JP) 2017-186865

(51) Int. Cl. G06F 3/0481; H04L 29/06; G06K 9/00; G06F 3/0484; G06F 3/0488

(52) U.S. Cl. CPC G06F 3/04817; H04L 63/0861; H04M 1/72522; G06F 3/04842; G06F 3/04883; G06K 9/00087

(57) ABSTRACT

An electronic apparatus includes a display surface located in a surface of the electronic apparatus, a controller, and a first sensor. The controller controls a display of the display surface. The first sensor detects a fingerprint of a finger touching a detection object surface located in a position different from the display surface in the surface of the electronic apparatus. The first sensor detects a first operation of a finger performed on the detection object surface along the detection object surface.

### CROSS-REFERENCE TO RELATED APPLICATION

The present application claims priority under 35 U.S.C. § 119 to Japanese Patent Application No. 2017-186865, filed on Sep. 27, 2017, entitled “ELECTRONIC APPARATUS”. The content of which is incorporated by reference herein in its entirety.

### FIELD

Embodiments of the present disclosure relate to an electronic apparatus.

### BACKGROUND

Various techniques are suggested regarding electronic apparatuses.

### SUMMARY

An electronic apparatus is disclosed. In one embodiment, an electronic apparatus comprises a display surface, at least one processor, and a first sensor. The display surface is located in a surface of the electronic apparatus. The at least one processor controls a display of the display surface. A first sensor detects a fingerprint of a finger touching a detection object surface being located in a position different from the display surface in the surface, and detect a first operation of a finger along the detection object surface performed on the detection object surface.

In one embodiment, an electronic apparatus having a plurality of planes in a surface comprises a display surface and a sensor. The display surface is located in one of the plurality of planes. The sensor detects an operation of a finger along a detection object surface performed on the detection object surface, the detection object surface located in a position different from the display surface in the one of the plurality of planes.

### BRIEF DESCRIPTION OF THE DRAWINGS

FIG. 1 illustrates a perspective view showing one example of an external appearance of an electronic apparatus.

FIG. 2 illustrates a rear view showing one example of the external appearance of the electronic apparatus.

FIG. 3 illustrates a block diagram showing one example of a configuration of the electronic apparatus.

FIG. 4 illustrates a drawing showing one example of a display of the electronic apparatus.

FIG. 5 illustrates a drawing showing one example of the display of the electronic apparatus.

FIG. 6 illustrates a drawing showing one example of the display of the electronic apparatus.

FIG. 7 illustrates a flow chart showing one example of an operation of the electronic apparatus.

FIG. 8 illustrates a flow chart showing one example of the operation of the electronic apparatus.

FIG. 9 illustrates a drawing showing one example of an operation performed on the electronic apparatus.

FIG. 10 illustrates a drawing showing one example of the display of the electronic apparatus.

FIG. 11 illustrates a drawing showing one example of the display of the electronic apparatus.

FIG. 12 illustrates a drawing showing one example of the display of the electronic apparatus.

FIG. 13 illustrates a drawing showing one example of the display of the electronic apparatus.

FIG. 14 illustrates a flow chart showing one example of the operation of the electronic apparatus.

FIG. 15 illustrates a flow chart showing one example of the operation of the electronic apparatus.

FIG. 16 illustrates a drawing showing one example of the operation performed on the electronic apparatus.

FIG. 17 illustrates a flow chart showing one example of the operation of the electronic apparatus.

FIG. 18 illustrates a flow chart showing one example of the operation of the electronic apparatus.

FIG. 19 illustrates a drawing showing one example of the display of the electronic apparatus.

FIG. 20 illustrates a front view showing one example of the external appearance of the electronic apparatus.

FIG. 21 illustrates a drawing showing one example of the display of the electronic apparatus.

FIG. 22 illustrates a drawing showing one example of the display of the electronic apparatus.

FIG. 23 illustrates a drawing showing one example of the display of the electronic apparatus.

FIG. 24 illustrates a drawing showing one example of the operation performed on the electronic apparatus.

FIG. 25 illustrates a rear view showing one example of the external appearance of the electronic apparatus.

FIG. 26 illustrates a perspective view showing one example of the external appearance of the electronic apparatus.

FIG. 27 illustrates a drawing showing one example of the operation performed on the electronic apparatus.

FIG. 28 illustrates a drawing showing one example of the operation performed on the electronic apparatus.

FIG. 29 illustrates a drawing showing one example of the operation performed on the electronic apparatus.

FIG. 30 illustrates a drawing showing one example of the operation performed on the electronic apparatus.

FIG. 31 illustrates a drawing showing one example of the operation performed on the electronic apparatus.

FIG. 32 illustrates a drawing showing one example of the operation performed on the electronic apparatus.

FIG. 33 illustrates a drawing showing one example of the display of the electronic apparatus.

FIG. 34 illustrates a drawing showing one example of the display of the electronic apparatus.

FIG. 35 illustrates a drawing showing one example of the display of the electronic apparatus.

FIG. 36 illustrates a drawing showing one example of the display of the electronic apparatus.

### DESCRIPTION OF THE PREFERRED EMBODIMENTS

<Example of External Appearance of Electronic Apparatus>

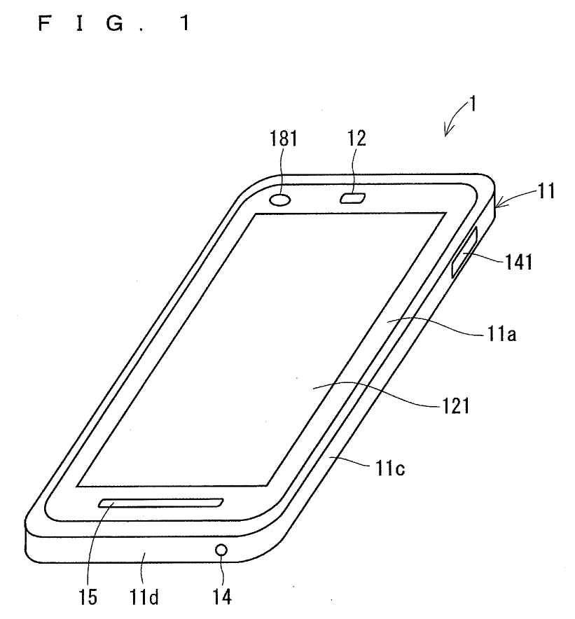

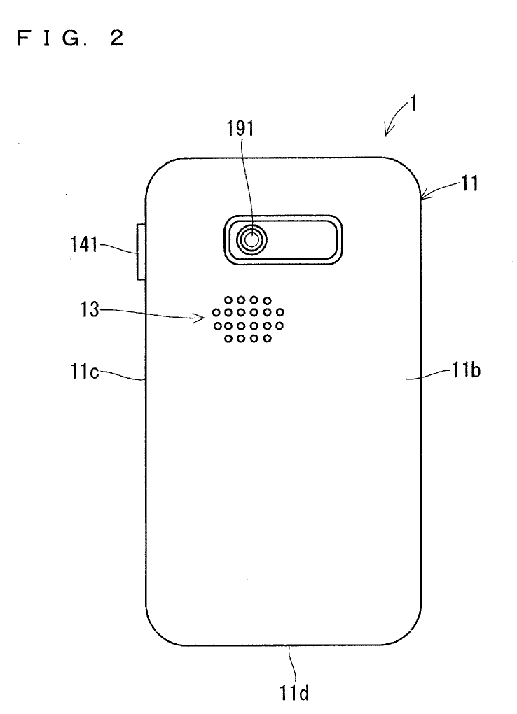

FIGS. 1 and 2 are a perspective view and a rear view showing one example of an external appearance of an electronic apparatus 1, respectively. As shown in FIGS. 1 and 2, the electronic apparatus 1 comprises an apparatus case 11 having a plate shape substantially rectangular in a plan view. The apparatus case 11 constitutes an outer package of the electronic apparatus 1.

A display surface 121, in which various types of information such as characters, symbols, and graphics are displayed, is located in a front surface 11a of the apparatus case 11, in other words, a front surface of the electronic apparatus 1. A touch panel 130, which will be described below, is located in a rear surface side of the display surface 121. Accordingly, a user can input various types of information to the electronic apparatus 1 by operating the display surface 121 in the front surface of the electronic apparatus 1 with his/her finger, for example. The user can also input the various types of information to the electronic apparatus 1 by operating the display surface 121 with a pen for the touch panel such as a stylus pen, for example, instead of an operator such as his/her finger. A location of the display surface 121 is not limited to an example in FIG. 1.

A receiver hole 12 is located in an upper end of the front surface 11a of the apparatus case 11. A microphone hole 14 is located in a side surface 11d in a lower side of the apparatus case 11. A lens 181 included in a first camera 180, which will be described below, can be visually recognized from the upper end of the front surface 11a of the apparatus case 11. As shown in FIG. 2, a lens 191 included in a second camera 190, which will be described below, can be visually recognized from a rear surface 11b of the apparatus case 11, in other words, the upper end of a rear surface of the electronic apparatus 1. A speaker hole 13 is located in the rear surface 11b of the apparatus case 11.

A detection object surface 15 is located in a lower end of the front surface 11a of the apparatus case 11. The electronic apparatus 1 can detect an operation performed on the detection object surface 15 by sensors 200 and 210 which will be described below. The detection object surface 15 is also referred to as a detection object region 15. A location of the detection object surface 15 is not limited to an example in FIG. 1.

The electronic apparatus 1 comprising an operation button group 140, which will be described below, including a plurality of operation buttons. Each operation button is a hardware button, for example, and is located in a surface of the apparatus case 11. Each of the plurality of operation buttons is a press button, for example. The operation button group 140 comprises a power source button 141. The power source button 141 is located in a side surface 11c on a right side of the apparatus case 11. In the present specification, the right side means a right side in a case of viewing the display surface 121. A left side means a left side in the case of viewing the display surface 121. The operation button group 140 includes an operation button other than the power source button 141. For example, the operation button group 140 includes a volume button.

The front surface 11a, the rear surface 11b, the side surface 11c on the right side, and the side surface 11d on the lower side of the apparatus case 11 are also referred to as the front surface 11a, the rear surface 11b, the side surface 11c on the right side, and the side surface 11d on the lower side of the electronic apparatus 1, respectively, in some cases hereinafter.

<Example of Electrical Configuration of Electronic Apparatus>

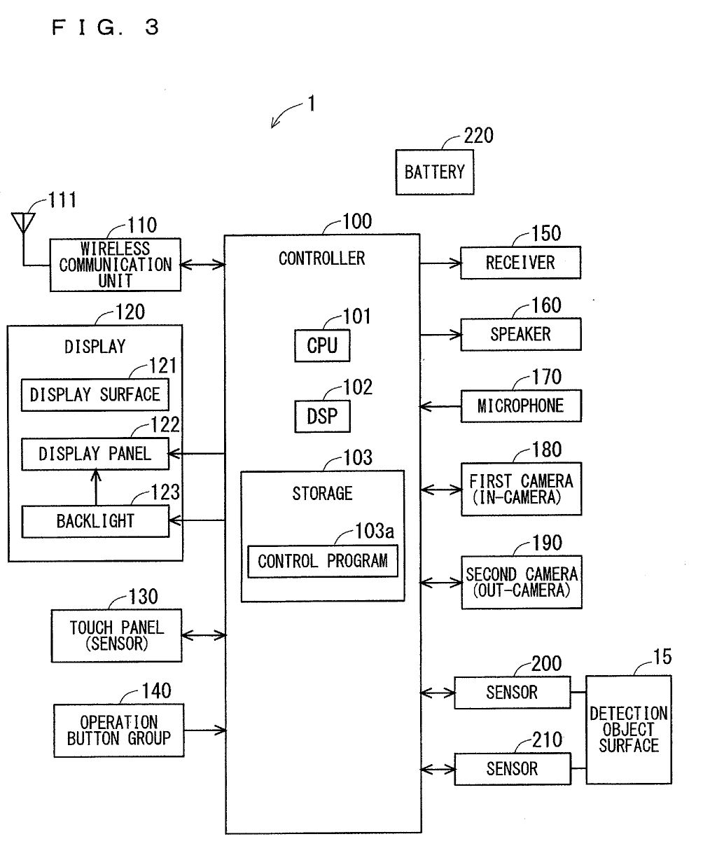

FIG. 3 is a block diagram showing one example of an electrical configuration of the electronic apparatus 1. As shown in FIG. 3, the electronic apparatus 1 comprises a controller 100, a wireless communication unit 110, a display 120, the touch panel 130, and the operation button group 140. The electronic apparatus 1 further comprises a receiver 150, a speaker 160, a microphone 170, the first camera 180, the second camera 190, the sensors 200 and 210, and a battery 220. The apparatus case 11 houses these components included in the electronic apparatus 1.

The controller 100 controls the other components of the electronic apparatus 1 to be able to collectively manage the operation of the electronic apparatus 1. The controller 100 is also considered as a control device or a control circuit. The controller 100 includes at least one processor for providing control and processing capability to execute various functions as described in detail below.

In accordance with various embodiments, the at least one processor may be implemented as a single integrated circuit (IC) or as multiple communicatively coupled IC's and/or discrete circuits. It is appreciated that the at least one processor can be implemented in accordance with various known technologies.

In one embodiment, the processor includes one or more circuits or units configurable to perform one or more data computing procedures or processes by executing instructions stored in an associated memory, for example. In the other embodiments, the processor may be implemented as firmware (e.g. discrete logic components) configured to perform one or more data computing procedures or processes.

In accordance with various embodiments, the processor may include one or more processors, controllers, microprocessors, microcontrollers, application specific integrated circuits (ASICs), digital signal processors, programmable logic devices, field programmable gate arrays, or any combination of these devices or structures, or other known devices and structures, to perform the functions described herein.

In the present example, the controller 100 comprises a central processing unit (CPU) 101, a digital signal processor (DSP) 102, and a storage 103. The storage 103 comprises a non-transitory recording medium readable by the CPU 101 and the DSP 102 such as a read only memory (ROM) and a random access memory (RAM). The ROM of the storage 103 is, for example, a flash ROM (flash memory) that is a non-volatile memory. The storage 103 stores a plurality of control programs 103a to control the electronic apparatus 1. The CPU 101 and the DSP 102 execute the various control programs 103a in the storage 103 to achieve various functions of the controller 100.

The controller 100 may comprise a plurality of CPUs 101. In the above case, the controller 100 may comprise a main CPU having a high processing capacity to perform comparative complex processing and a sub CPU having a low processing capacity to perform comparative simple processing. It is also applicable that the controller 100 does not comprise the DSP 102 or comprises a plurality of DSPs 102. All or some of the functions of the controller 100 may be achieved by a hardware circuit that needs no software to achieve the functions above.

The storage 103 may comprise a non-transitory computer readable recording medium other than the ROM and the RAM. The storage 103 may comprise, for example, a compact hard disk drive and a solid state drive (SSD).

The plurality of control programs 103a in the storage 103 include various applications (that is to say, application programs). The storage 103 stores, for example, a call application to perform a voice call and a video call, a browser to display a website, and a mail application to create, browse, send, and receive an e-mail. The storage 103 also stores a camera application to take a picture of an object using the first camera 180 and the second camera 190, a recorded image display application to display a still image and a video recorded in the storage 103, and a music reproduction control application to control a reproduction of music data stored in the storage 103. The storage 103 may store at least one application in the storage 103 in advance. The electronic apparatus 1 may download the at least one application in the storage 103 from the other device and store it in the storage 103.

The wireless communication unit 110 comprises an antenna 111. The wireless communication unit 110 can perform a wireless communication in several types of communication systems, for example, using the antenna 111. The controller 100 controls the wireless communication of the wireless communication unit 110.

The wireless communication unit 110 can perform a wireless communication with a base station of a mobile phone system. The wireless communication unit 110 can communicate with a mobile phone different from the electronic apparatus 1 or a web server via a network such as the base station or Internet. The electronic apparatus 1 can perform a data communication, a voice call and a video call with the other mobile phone, for example.

The electronic apparatus 1 can perform a wireless communication using the wireless communication unit 110 and a wireless local area network (LAN) such as WiFi. The wireless communication unit 110 can perform a near field wireless communication. For example, the wireless communication unit 110 can perform the wireless communication in conformity to Bluetooth (registered trademark). The wireless communication unit 110 may perform the wireless communication in conformity to at least one of ZigBee (registered trademark) and near field communication (NFC).

The wireless communication unit 110 can perform various types of processing such as amplification processing on a signal received by the antenna 111 and then outputs a resultant signal to the controller 100. The controller 100 can perform the various types of processing on the received signal which has been input, to obtain information contained in the received signal. The controller 100 outputs a transmission signal containing the information to the wireless communication unit 110. The wireless communication unit 110 can perform the various types of processing such as amplification processing on the transmission signal being has been input, and then wirelessly transmits a resultant signal from the antenna 111.

The display 120 comprises the display surface 121, a display panel 122, and a backlight 123 located in the front surface 11a of the electronic apparatus 1. The display 120 can display various types of information on the display surface 121. The display panel 122 is, for example, a liquid crystal display panel and includes a plurality of pixels (also referred to as “a pixel unit” or “a pixel circuit”). The display panel 122 includes a liquid crystal, a glass substrate, or a polarization plate, for example. The display panel 122 faces the display surface 121 in the apparatus case 11. The display surface 121 of the surface of the electronic apparatus 1 displays the information displayed in the display 120. The backlight 123 emits light to the display panel 122 from a back side of the display panel 122. The backlight 123 includes at least one light-emitting diode (LED), for example. The display panel 122 can control a transmission amount of light transmitted from the backlight 123 by pixel unit under control of the controller 100. The display panel 122 can thereby display the various types of information. When the controller 100 controls each pixel of the display panel 122 in a state where the backlight 123 is turned on, the display 120 can display the various types of information such as characters, signs, and graphics. The controller 100 can control the backlight 123. The controller 100 can turn on and off the backlight 123, for example.

The display panel 122 may be a display panel other than the liquid crystal display panel. For example, the display panel 122 may be a self-luminous display panel such as an organic electroluminescence (EL) panel. The backlight 123 is not necessary in the above case.

The touch panel 130 can detect an operation performed on the display surface 121 with the operator such as the finger. The touch panel 130 is deemed to be a sensor detecting the operation performed on the display surface 121. The touch panel 130 is, for example, a projected capacitive touch panel. The tough panel 130 is located on a back side of the display surface 121, for example. When the user performs the operation on the display surface 121 with the operator such as his/her finger, the touch panel 130 can input, to the controller 100, an electrical signal in accordance with the operation. The controller 100 can specify contents of the operation performed on the display surface 121 based on the electrical signal (output signal) from the touch panel 130. The controller 100 can perform the processing in accordance with the specified operation contents. An in-cell display panel in which a touch panel is incorporated may be adopted instead of the display panel 122 and the touch panel 130.

When the user operates each operation button of the operation button group 140, the operation button can output to the controller 100 an operation signal indicating that the operation button has been operated. The controller 100 can accordingly determine whether or not each operation button has been operated for each operation button. The controller 100 to which the operation signal is input controls the other component, thereby causing the electronic apparatus 1 to execute the function allocated to the operated operation button.

The microphone 170 can convert a sound from the outside of the electronic apparatus 1 into an electrical sound signal and then output the electrical sound signal to the controller 100. The sound from the outside of the electronic apparatus 1 is taken inside the electronic apparatus 1 through the microphone hole 14 and input to the microphone 170.

The speaker 160 is, for example, a dynamic speaker. The speaker 160 can convert an electrical sound signal from the controller 100 into a sound and then output the sound. The sound being output from the speaker 160 is output outside through the speaker hole 13. The user can hear the sound being output from the speaker hole 13 in a place apart from the electronic apparatus 1.

The receiver 150 can output a received sound. The receiver 150 is, for example, a dynamic speaker. The receiver 150 can convert an electrical sound signal from the controller 100 into a sound and then output the sound. The sound being output from the receiver 150 is output outside through the receiver hole 12. A volume of the sound being output through the receiver hole 12 is set to be smaller than a volume of the sound being output through the speaker hole 13. The user brings the receiver hole 12 close to his/her ear, thereby being able to hear the sound being output through the receiver hole 12. A vibration element such as a piezoelectric vibration element for causing a portion of the front surface of the apparatus case 11 to vibrate may be provided instead of the receiver 150. In the above case, the sound is transmitted to the user in a form of the vibration of the portion of the front surface.

The first camera 180 comprises the lens 181, an image sensor, and so on. The second camera 190 comprises the lens 191, an image sensor, and so on. Each of the first camera 180 and the second camera 190 can take an image of an object under control of the controller 100, generate a still image or a video of the object, and then output the still image or the video to the controller 100.

The lens 181 of the first camera 180 can be visually recognized from the front surface 11a of the apparatus case 11. Accordingly, the first camera 180 can take an image of an object located on a front surface side (in other words, the display surface 121 side) of the electronic apparatus 1. The first camera 180 is referred to as an in-camera. In the meanwhile, the lens 191 of the second camera 190 can be visually recognized from the rear surface 11b of the apparatus case 11. Accordingly, the second camera 190 can take an image of an object located on a rear surface side of the electronic apparatus 1. The second camera 190 is referred to as an out-camera.

The sensor 200 can detect a fingerprint of the finger touching the detection object surface 15. Herein, the touch of the detection object surface 15 with the finger includes both a state where the finger is lightly attached to the detection object surface 15 and a state where the finger presses the detection object surface 15 (in other words, the finger pushes the detection object surface 15). Accordingly, the sensor 200 can detect the fingerprint of the finger when the finger is lightly attached to the detection object surface 15. The sensor 200 can detect the fingerprint of the finger when the finger presses the detection object surface 15. The sensor 200 can detect the fingerprint of the finger in any of the cases where the finger presses the detection object surface 15 weakly or hard.

The sensor 200 can detect an operation performed by the operator such as the finger along the detection object surface 15. For example, the sensor 200 can detect a slide operation and a flick operation performed by the operator on the detection object surface 15. The slide operation refers to an operation of moving an operator such as the finger which is kept in contact with an operation object surface. The flick operation refers to an operation of flicking the operation object surface with the operator such as the finger. The operation performed by the operator along the detection object surface 15 is referred to as “the movement operation” in some cases hereinafter.

In the present example, as shown in FIG. 1, the detection object surface 15 has an elongated shape along a right and left direction (in other words, a short side direction) of the electronic apparatus 1. The sensor 200 can detect the movement operation in the right and left direction performed on the detection object surface 15. It is also applicable that the sensor can detect the movement operation in the other direction as well as the right and left direction. For example, the sensor 200 can detect the movement operation in the right and left direction and an up and down direction performed on the detection object surface 15.

A fingerprint detection system in the sensor 200 is, for example, a capacitance system. Since the capacitance between the sensor 200 and the finger changes in accordance with an unevenness caused by the fingerprint, the sensor 200 can detect the fingerprint by detecting the capacitance between the sensor 200 and the finger. When the fingerprint detection system in the sensor 200 is the capacitance system, the sensor 200 can detect the movement operation performed on the detection object surface 15 in the manner similar to the capacitive touch panel 130.

The sensor 200 may be made up of two separated sensors of a sensor detecting the fingerprint of the finger touching the detection object surface 15 and a sensor detecting the movement operation performed on the detection object surface 15. A system other than the capacitance system may also be adopted as the fingerprint detection system in the sensor 200. For example, an optical system may be adopted as the fingerprint detection system in the sensor 200. The fingerprint detected by the sensor 200 is referred to as “the detected fingerprint” in some cases hereinafter.

The sensor 210 can detect a pressing force exerted by the finger on the detection object surface 15. The sensor 210 is, for example, a pressure sensor. The sensor 210 may be a piezoelectric sensor detecting an oscillation of the finger touching the detection object surface 15, for example. The finger of a human oscillates in accordance with an action of a muscle and a pulse, and a temporal change of the oscillation shows a characteristic pattern. When the finger presses a surface, the characteristic pattern in the temporal change of the oscillation of the finger changes in accordance with the pressing force of the finger. The piezoelectric sensor can detect the pressing force exerted by the finger on the detection object surface 15 by detecting the pattern in the temporal change of the oscillation of the finger touching the detection object surface 15. The controller 100 can specify whether the detection object surface 15 is touched by the finger of the human or touched by an object other than the finger of the human based on a detection value of the piezoelectric sensor.

The battery 220 can output a power source for the electronic apparatus 1. The battery 220 is, for example, a rechargeable battery. The battery 220 can supply the power source to various components such as the controller 100 and the wireless communication unit 110 included in the electronic apparatus 1.

The electronic apparatus 1 may comprise a sensor other than the touch panel 130 and the sensors 200 and 210. For example, the electronic apparatus 1 may comprise at least one of an acceleration sensor, an atmospheric pressure sensor, a geomagnetic sensor, a temperature sensor, a proximity sensor, an illuminance sensor, and a gyro sensor.

<Example of Operation Mode of Electronic Apparatus>

The electronic apparatus 1 has a large number of operation modes. The operation modes of the electronic apparatus 1 include, for example, a normal mode, a sleep mode, and a shutdown mode. In the shutdown mode, the electronic apparatus 1 is shut down, and most functions of the electronic apparatus 1 are suspended. In the sleep mode, some functions of the electronic apparatus 1, including a display function, are suspended. Operating in the normal mode means that the electronic apparatus 1 operates in a mode other than the sleep mode and the shutdown mode. The controller 100 sets the operation mode of the electronic apparatus 1 by controlling predetermined components of the electronic apparatus 1 in accordance with the operation mode to be set.

In the sleep mode, for example, some components of the electronic apparatus 1, including the display panel 122, the backlight 123, the touch panel 130, the first camera 180, and the second camera 190, do not operate. In the shutdown mode, most components of the electronic apparatus 1, including the display panel 122, the backlight 123, the touch panel 130, the first camera 180, and the second camera 190, do not operate. In the sleep mode, the electronic apparatus 1 consumes less power than in the normal mode. In the shutdown mode, the electronic apparatus 1 consumes less power than in the sleep mode.

In the sleep mode and in the shutdown mode, the display surface 121 is in a non-display mode. Herein, a display state indicates a state where the electronic apparatus 1 purposely displays the information on the display surface 121. The non-display state indicates a state where the electronic apparatus 1 does not purposely display the information on the display surface 121. In the present example, when the backlight 123 is turned off, the electronic apparatus 1 cannot purposely display the information on the display surface 121. Accordingly, when the backlight 123 is turned off, the display surface 121 enters the non-display state. In other words, when the backlight 123 is not driven, the display surface 121 is in the non-display state. In a case where the display panel 122 is a self-luminous display panel such as an organic EL panel, when no pixel emits light, the display surface 121 is in the non-display mode. That is to say, when the whole region in the display region of the display panel 122 is in the lighting-off state, the display surface 121 is in the non-display state.

If the power source button 141 is pressed for a long time in the normal mode, the display surface 121 displays a confirmation screen to confirm with the user about whether or not to make the operation mode transition from the normal mode to the shutdown mode. If the user performs a predetermined operation on the display surface 121 in a state where the display surface 121 displays the confirmation screen, the operation mode transitions from the normal mode to the shutdown mode.

If no operation is performed on the electronic apparatus 1 for a given period of time or more in the normal mode, the operation mode transitions from the normal mode to the sleep mode. The operation mode transitions from the normal mode to the sleep mode when the power source button 141 is pressed for a short time in the normal mode.

In the meanwhile, the operation mode transitions from the sleep mode to the normal mode when the power source button 141 is pressed for a short time in the sleep mode. That is to say, when the power source button 141 is pressed for a short time in the sleep mode, the functions suspended at transition to the sleep mode are restored in the electronic apparatus 1. The normal mode in the present example includes a lock mode which will be described hereinafter. The operation mode transitions from the sleep mode to the lock mode when the power source button 141 is pressed for a short time in the sleep mode. The operation mode transitions from the sleep mode to the normal mode when a predetermined operation is performed on the detection object surface 15 in the sleep mode.

The normal mode includes the operation mode of the electronic apparatus 1 described below other than the shutdown mode and the sleep mode without a particular description. The operation mode simply means the operation mode of the electronic apparatus 1. An operation of pressing the surface of the electronic apparatus 1 for a short time without changing a press position, that is to say, an operation of pressing the surface of the electronic apparatus 1 for a first given period of time or less without changing a press position is referred to as “a short press operation”. An operation of pressing the surface of the electronic apparatus 1 for a long time without changing a press position, that is to say, an operation of pressing the surface of the electronic apparatus 1 for a second given period of time or more the first given period of time) without changing a press position is referred to as a “long press operation”.

<Example of Screen Displayed in Display Region>

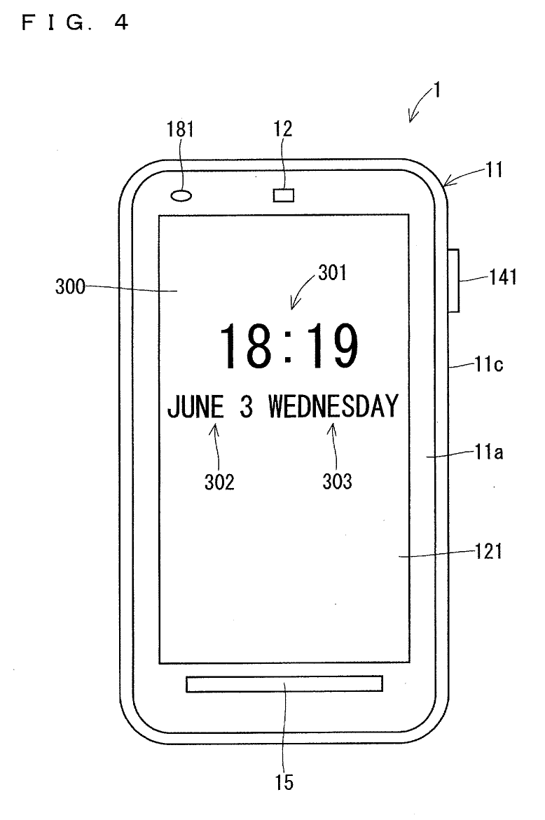

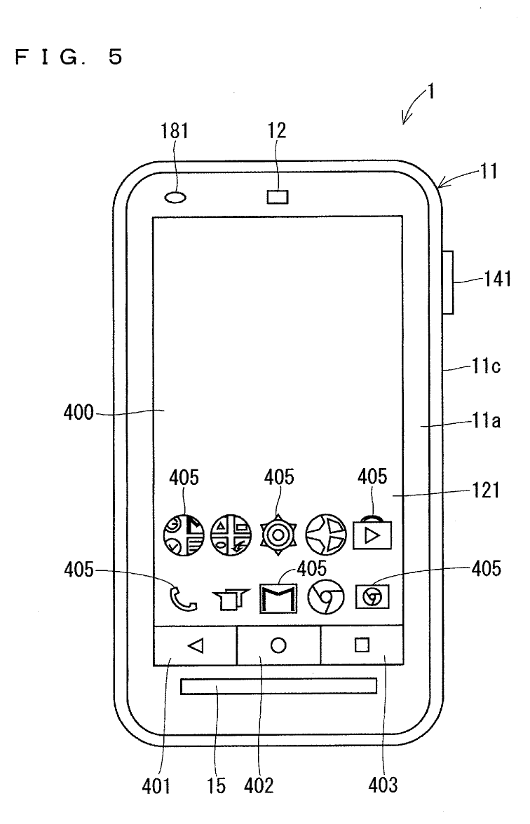

The display surface 121 displays various screens in the normal mode. The screen displayed on the display surface 121 is also deemed to be an image displayed on the display surface 121. The display surface 121 displays a home screen and a lock screen, for example. FIG. 4 is a drawing showing one example of a lock screen 300. FIG. 5 is a drawing showing one example of a home screen 400.

As shown in FIG. 4, the lock screen 300 indicates a current time 301, a current date 302, and a current day 303, for example.

The normal mode herein includes a lock mode in which the user cannot make the electronic apparatus 1 execute any applications other than specific applications (e.g., the call application and the camera application) of a plurality of applications stored in the storage 103. The lock mode is also referred to as the screen lock mode. In the lock mode, the user cannot instruct the electronic apparatus 1 to execute each of the applications other than the specific applications of the plurality of applications stored in the storage 103. The lock screen 300 is a screen indicating that the electronic apparatus 1 is in the lock mode, and is displayed on the display surface 121 when the operation mode is the lock mode. In the lock mode, it is not necessary for the user to be able to make the electronic apparatus 1 execute all the applications stored in the storage 103.

When the short press operation is performed on the power source button 141 in the sleep mode, the sleep mode is canceled, and the operation mode of the electronic apparatus 1 transitions to the lock mode. The lock screen 300 is thus displayed on the display surface 121. When the user performs a predetermined operation on the electronic apparatus 1 during display of the lock screen 300 on the display surface 121, the lock mode of the electronic apparatus 1 is canceled, and the display on the display surface 121 transitions from the lock screen 300 to another screen, such as the home screen 400 (refer to FIG. 5), for example. A state where the lock mode has been canceled in the normal mode is also referred to as an “unlock mode” in some cases hereinafter.

The home screen 400 shows a plurality of operation buttons 401 to 403 as shown in FIG. 5. Each of the operation buttons 401 to 403 is a software button. The operation buttons 401 to 403 are also shown in a screen other than the home screen 400 in the unlock mode.

The operation buttons 401 is a back button, for example. The back button is an operation button for switching the display on the display surface 121 to the immediately preceding display. The user performs a predetermined operation on the operation button 401 to switch the display on the display surface 121 to the immediately preceding display. For example, the user performs a tap operation on the operation button 401 to switch the display on the display surface 121 to the immediately preceding display. The tap operation refers to an operation of the user taking the finger off a touch position on the operation object surface right after touching the operation object surface. The operation buttons 402 is a home button, for example. The home button is an operation button for displaying the home screen 400 on the display surface 121. When the user performs the tap operation on the operation button 402, for example, the display surface 121 displays the home screen. The operation button 403 is a history button, for example. The history button is an operation button to display a history of an application executed by the electronic apparatus 1 on the display surface 121. When the user performs the tap operation on the operation button 403, for example, the display surface 121 displays a history of the applications executed by the electronic apparatus 1.

The home screen 400 shows an icon 405, corresponding to the application in the storage 103, for instructing the electronic apparatus 1 to execute the corresponding application. In the example in FIG. 5, the home screen 400 shows ten icons 405. The user can select the icon 405 by performing a predetermined operation (e.g., a tap operation) on the icon 405. The controller 100 reads, from the storage 103, an application corresponding to the selected icon 405 and executes the application. That is to say, when the touch panel 130 detects the predetermined operation performed on the icon 405, the controller 100 reads, from the storage 103, the application corresponding to the icon 405 and executes the application. The user can thus select the icon 405 by operating the icon 405 and make the electronic apparatus 1 execute the application corresponding to the selected icon 405. For example, when the user performs the tap operation on the icon 405 corresponding to a browser, the electronic apparatus 1 executes the browser. When the user performs the tap operation on the icon 405 corresponding to a camera application, the electronic apparatus 1 executes the camera application.

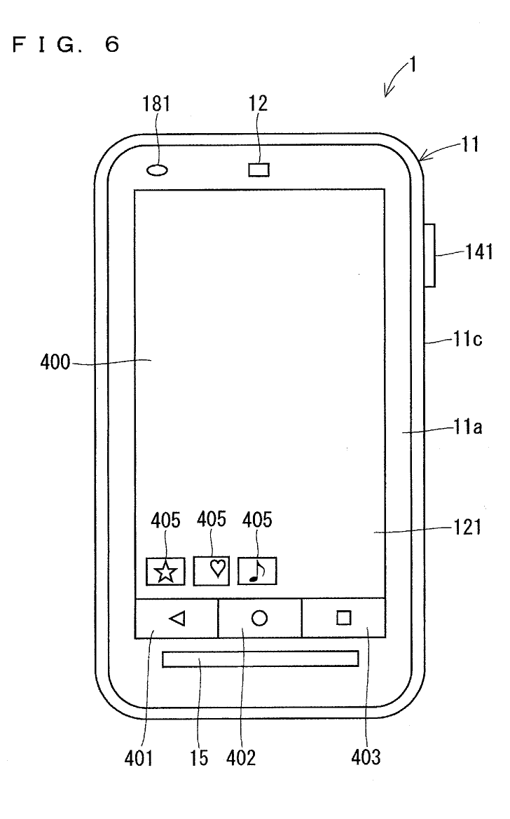

A plurality of pages constitute the home screen 400. FIG. 5 illustrates a page of the home screen 400. Each page shows the operation buttons 401 to 403 and the icon 405. The plurality of pages constituting the home screen 400 are virtually arranged in the right and left direction. When the user performs the flick operation or the slide operation in the right and left direction on the display surface 121, the display surface 121 displays the adjacent page. FIG. 6 is a drawing showing a page different from that in FIG. 5. Each page in the home screen 400 is also deemed to be a type of screen displayed on the display surface 121.

<Example of Fingerprint Authentication>

When the operation mode is the normal mode, the controller 100 can perform a fingerprint authentication based on a fingerprint detected by the sensor 200. One example of the fingerprint authentication is described below.

In the fingerprint authentication, the controller 100 generates a fingerprint image indicating a fingerprint detected by the sensor 200, that is to say, the detected fingerprint based on an output signal from the sensor 200. Then, the controller 100 extracts a feature point indicating a feature of the detected fingerprint from the generated fingerprint image. Applied to the feature point are, for example, positions of an end point and a branch point of a ridge line (a convex portion) of the fingerprint and a thickness of the edge line. Then, the controller 100 compares the extracted feature point and a reference feature point stored in the storage 103. The reference feature point is a feature point extracted from a fingerprint image showing a fingerprint of an authorized user (e.g., an owner of the electronic apparatus 1). The controller 100 determines that the fingerprint authentication has succeeded if the extracted feature point and the reference feature point are similar to each other as a result of comparison. The fingerprint authentication is one type of user authentication, and thus it can be said that the controller 100 determines that the user having the fingerprint detected by the sensor 200 is the authorized user if the extracted feature point and the reference feature point are similar to each other. On the other hand, the controller 100 determines that the fingerprint authentication has failed if the extracted feature point and the reference feature point are not similar to each other. This means that the controller 100 determines that the user having the fingerprint detected by the sensor 200 is an unauthorized user.

The normal mode includes a fingerprint registration mode for registering the fingerprint of the user in the electronic apparatus 1. The electronic apparatus 1 operates in the fingerprint registration mode when a predetermined operation is performed on the display surface 121 in the unlock mode. When the authorized user places his/her finger (particularly, a finger pad) on the detection object surface 15 in the fingerprint registration mode, the sensor 200 detects the fingerprint of his/her finger. The controller 100 generates a fingerprint image indicating the fingerprint detected by the sensor 200 based on an output signal from the sensor 200. Then, the controller 100 extracts a feature point from the generated fingerprint image, and stores the extracted feature point in the storage 103 as the reference feature point. The reference feature point representing features of the fingerprint of the authorized user is thus stored in the storage 103. This means that the fingerprint of the authorized user is registered in the electronic apparatus 1.

In some cases, a plurality of reference feature points are stored in the storage 103. In such cases, the controller 100 compares the extracted feature point with each of the plurality of reference feature points stored in the storage 103. The controller 100 determines that the fingerprint authentication has succeeded if the extracted feature point is similar to any of the plurality of reference feature points. On the other hand, the controller 100 determines that the fingerprint authentication has failed if the extracted feature point is similar to none of the plurality of reference feature points.

<Example of Method of Canceling Sleep Mode Using Detection Object Surface>

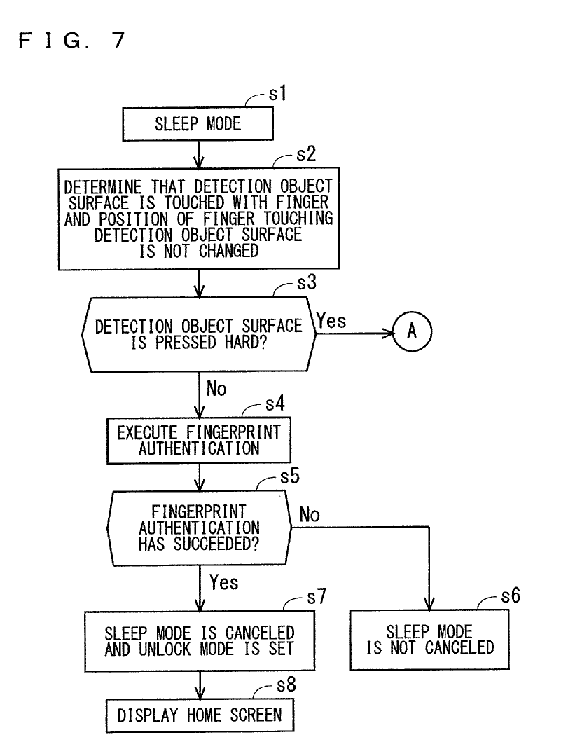

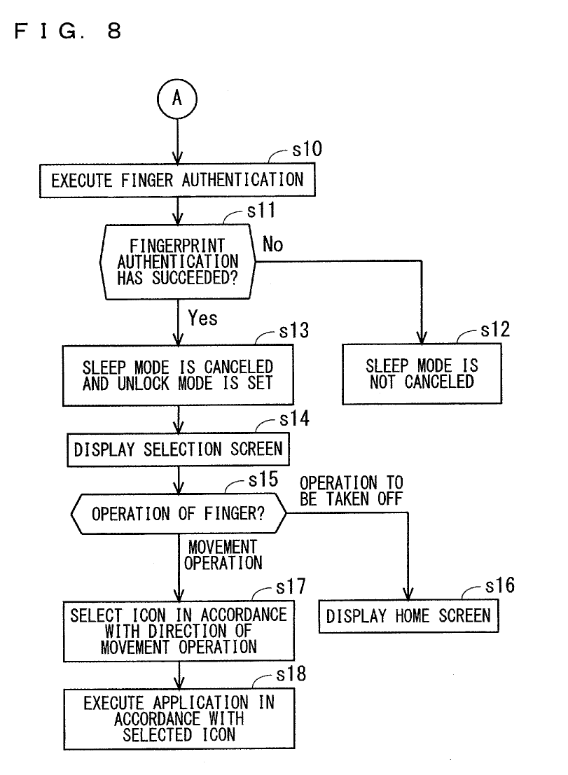

When the operation mode is the sleep mode, the user can make the electronic apparatus 1 cancel the sleep mode by performing a predetermined operation on the detection object surface 15. FIGS. 7 and 8 are flow charts showing one example of an operation of the electronic apparatus 1 when the electronic apparatus 1 cancels the sleep mode.

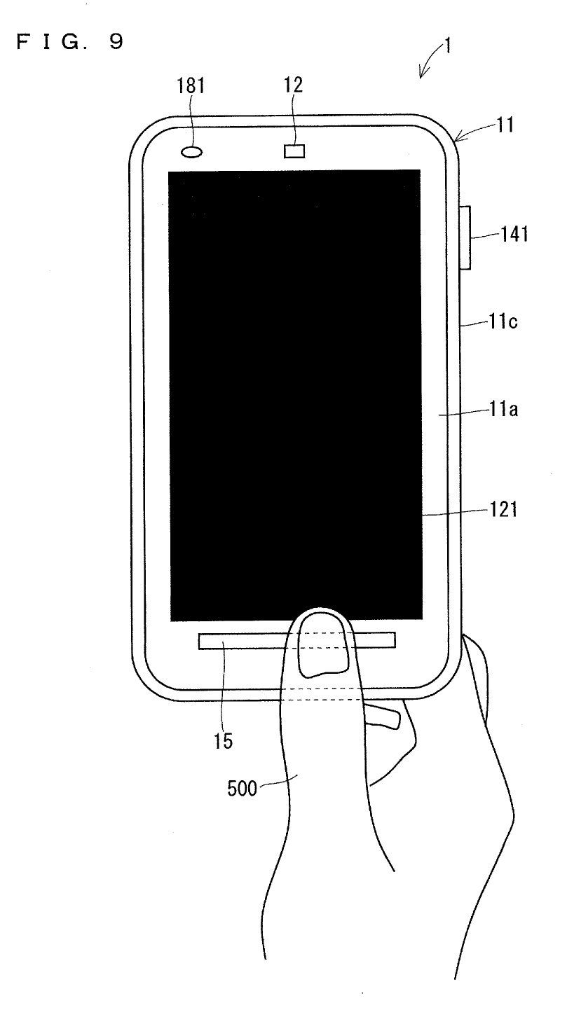

As shown in FIG. 7, in a case where the operation mode is the sleep mode (Step s1), when the controller 100 determines that the detection object surface 15 is being touched with the finger and the position in the detection object surface 15 touched with the finger does not change based on the output signal from the sensor 200 in Step s2, the controller 100 executes Step s3. Thus, if the human operating the electronic apparatus 1 touches the detection object surface 15 with his/her finger without moving his/her finger along the detection object surface 15, Step s3 is executed. FIG. 9 is a drawing showing a state where the detection object surface 15 is touched with a finger 500 and the position in the detection object surface 15 touched with the finger 500 does not change when the operation mode is the sleep mode. FIG. 9 is also deemed to show a state where the human operating the electronic apparatus 1 touches the detection object surface 15 with the finger 500 without moving the finger 500 along the detection object surface 15. FIG. 9 shows a state where the detection object surface 15 is touched with a thumb as one example. The display surface 121 shown in FIG. 9 is in the non-display state.

In Step s3, the controller 100 determines whether or not the detection object surface 15 is pressed hard by the finger based on the detection result in the sensor 210. If the pressing force detected by the sensor 210 is larger than a first threshold value, the controller 100 determines that the detection object surface 15 is pressed hard by the finger. Then, the controller 100 executes Step s10 (refer to FIG. 8). Thus, if the detection object surface 15 is pressed hard by the finger in the state where the finger does not move along the detection object surface 15, Step s10 is executed.

In the meanwhile, if the pressing force detected by the sensor 210 is equal to or smaller than the first threshold value, the controller 100 determines that the detection object surface 15 is not pressed hard by the finger. Then, the controller 100 executes Step s4. Thus, if the detection object surface 15 is pressed weakly by the finger in the state where the finger does not move along the detection object surface 15, Step s4 is executed. If the finger is lightly attached to the detection object surface 15 in the state where the finger does not move along the detection object surface 15, Step s4 is executed.

It is also applicable that the controller 100 determines that the detection object surface 15 is pressed hard by the finger if the pressing force detected by the sensor 210 is equal to or larger than the first threshold value, and determines that the detection object surface 15 is not pressed hard by the finger if the pressing force is smaller than the first threshold value.

In each of Step s4 and Step s10, the controller 100 performs the fingerprint authentication based on the fingerprint detected by the sensor 200 as described above. After Step s4, the controller 100 determines whether or not the fingerprint authentication has succeeded in Step s5. In the similar manner, after Step s10, the controller 100 determines whether or not the fingerprint authentication has succeeded in Step s11. If it is determined that the fingerprint authentication has failed in Step s5, the controller 100 does not cancel the sleep mode in Step s6. In the similar manner, if it is determined that the fingerprint authentication has failed in Step s11, the controller 100 does not cancel the sleep mode in Step s12.

As described above, since the sleep mode is not canceled in the present example if the fingerprint authentication has failed, the display surface 121 is kept in the non-display state.

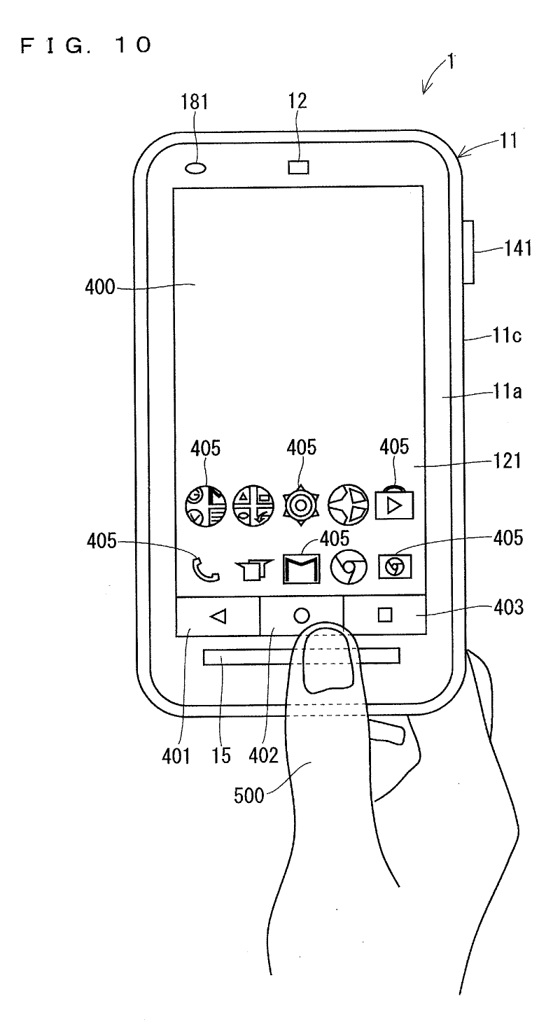

In the meanwhile, if it is determined that the fingerprint authentication has succeeded in Step s5, the controller 100 cancels the sleep mode and sets the operation mode to the unlock mode in Step s7. Then, in Step s8, the controller 100 displays the home screen 400 on the display surface 121 as shown in FIG. 10. Thus, the authorized user can make the electronic apparatus 1 display the home screen 400 by pressing the detection object surface 15 weakly with his/her finger without moving his/her finger along the detection object surface 15. The authorized user can make the electronic apparatus 1 display the home screen 400 by attaching his/her finger to the detection object surface 15 lightly without moving his/her finger along the detection object surface 15. In Step s8, the screen which has been displayed on the display surface 121 immediately before the operation mode is set to the sleep mode (also referred to as the “last display screen” hereinafter) may be displayed on the display surface 121. In such a case, if the screen of the browser being executed has been displayed on the display surface 121 immediately before the operation mode is set to the sleep mode, the screen of the browser is displayed in Step s8.

If it is determined that the fingerprint authentication has succeeded in Step s11, the controller 100 cancels the sleep mode and sets the operation mode to the unlock mode in Step s13. Then, the controller 100 displays a selection screen 600 through which the user selects the application to be executed by the electronic apparatus 1 on the display surface 121.

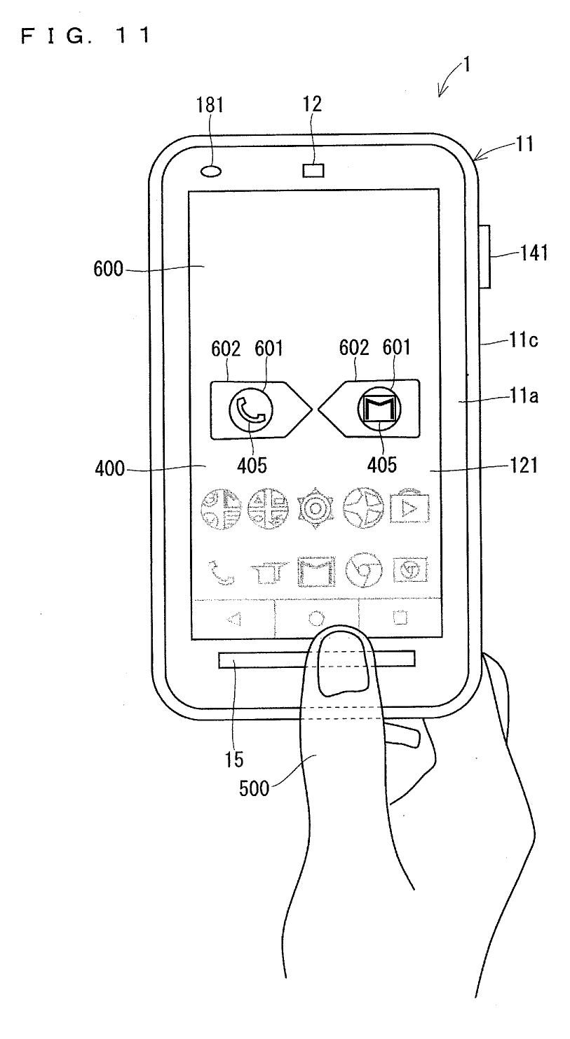

FIG. 11 is a drawing showing one example of the selection screen 600. As shown in FIG. 11, the selection screen 600 shows the plurality of icons 405. In the example in FIG. 11, the selection screen 600 shows the two icons 405 arranged in the right and left direction of the display surface 121. The user can select the icon 405 corresponding to the application which the electronic apparatus 1 is made to execute by performing the movement operation of the finger on the detection object surface 15. The selection screen 600 shows the icons 405 each located in a circle 601. The selection screen 600 shows graphics 602 each corresponding to the icon 405 and indicating that the corresponding icon 405 is selected. The graphic 602 has a rectangular shape whose one end in a longitudinal direction has a triangle shape, for example. The graphic 602 surrounds the icon 405 and the circle 601 which surrounds the icon 405. The two graphics 602 which surround the two icons 405 arranged in the right and left direction, respectively, are disposed so that the longitudinal direction of the graphics 602 is directed along the right and left direction of the display surface 121 and corners of triangle chevrons each located on one end of the graphic 602 face each other. When the icon 405 is selected, a color in the graphic 602 surrounding the selected icon 405 changes. Thus, the user can recognize that the selected icon 405 is correctly selected.

The icon 405 included in the selection screen 600 may be the icon 405 designated by the user or the icon 405 determined by the electronic apparatus 1 itself. In the former case, the user can designate the icon 405 included in the selection screen 600 for the electronic apparatus 1 by operating the display surface 121, for example. In the latter case, the controller 100 comprises the icon 405 corresponding the application which is frequently executed in the selection screen 600, for example.

In the example in FIG. 11, the selection screen 600, which is a semi-transparent screen, has an overlap with the home screen 400. Accordingly, the user transparently views the home screen 400 located under the selection screen 600 through the selection screen 600. It is also applicable that the selection screen 600 is a non-transparent screen and does not have an overlap with the home screen 400.

If the selection screen 600 is displayed in Step s14, the controller 100 specifies the operation of the finger detected by the sensor 200 based on the output signal from the sensor 200 in Step s15. If the controller 100 determines that the sensor 200 detects the movement operation performed by the finger on the detection object surface 15 in Step s15, the controller 100 selects the icon 405 in the selection screen 600 in accordance with the direction of the movement operation of the finger detected by the sensor 200 in Step s17. Then, the controller 100 reads, from the storage 103, the application corresponding to the selected icon 405 and executes the application. Subsequently, the display surface 121 displays the screen in accordance with the application being executed.

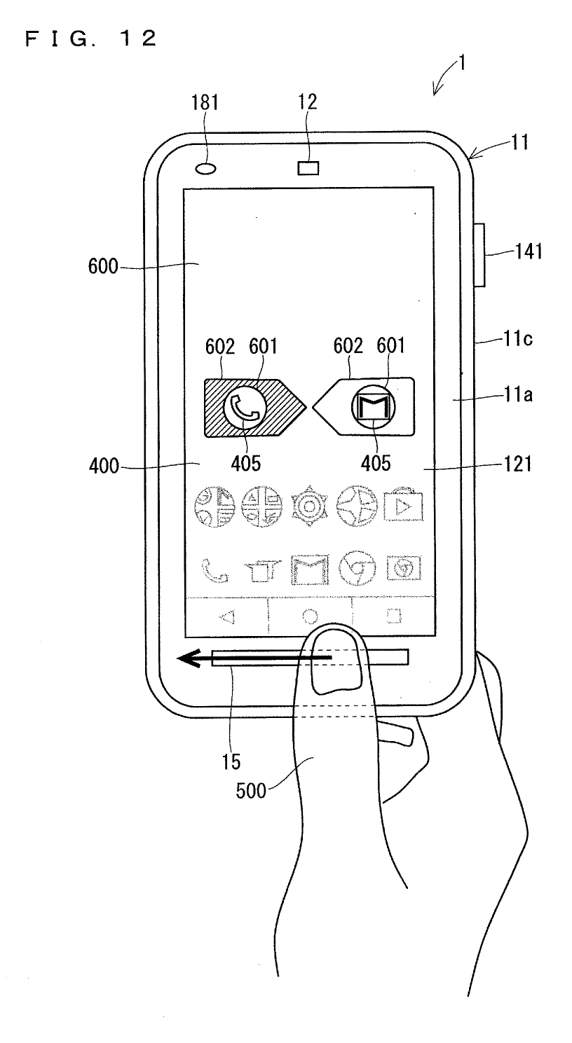

In the present example, as shown in FIG. 12, when the direction of the movement operation of the finger 500 detected by the sensor 200 is the left direction, that is to say, when the finger 500 moves in the left direction while touching the detection object surface 15, the icon 405 located on the left side in the two icons 405 in the selection screen 600 is selected. As a result, the color in the graphic 602 surrounding the icon 405 located on the left side changes. FIG. 12 shows that the color in the graphic 602 surrounding the selected icon 405 has changed by diagonal lines. The same applies to the drawings shown hereinafter.

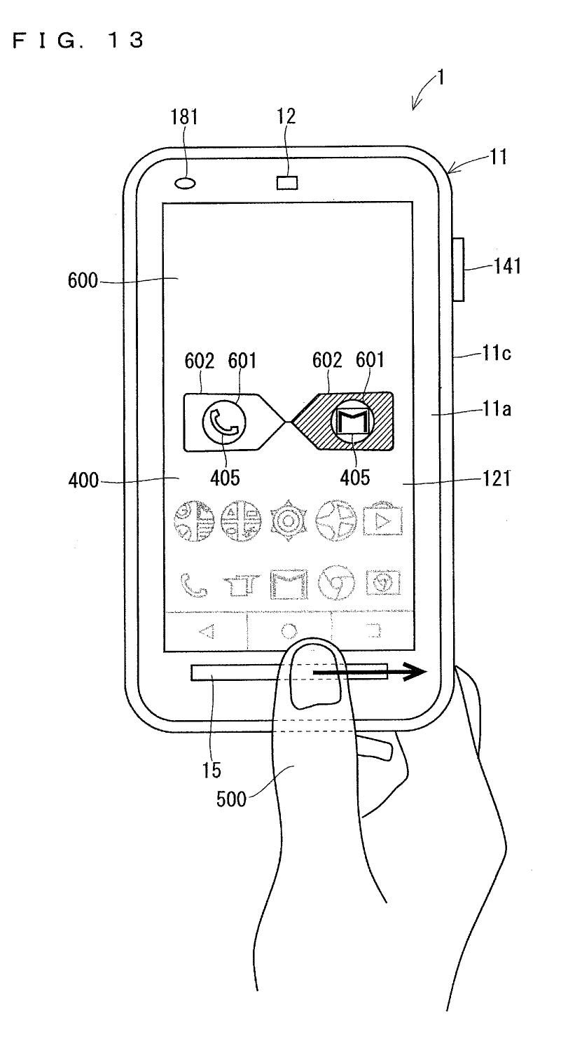

In the meanwhile, as shown in FIG. 13, when the direction of the movement operation of the finger 500 detected by the sensor 200 is the right direction, that is to say, when the finger 500 moves in the right direction while touching the detection object surface 15, the icon 405 located on the right side in the two icons 405 in the selection screen 600 is selected. As a result, the color in the graphic 602 surrounding the icon 405 located on the right side changes.

In the present example, the controller 100 can select the icon 405 in accordance with the direction of the flick operation performed by the finger on the detection object surface 15. If the sensor 200 detects the flick operation in the left direction performed by the finger on the detection object surface 15, the controller 100 selects the icon 405 located on the left side in the selection screen 600, and changes the color in the graphic 602 surrounding the icon 405 located on the left side in Step s17. Then, the controller 100 executes the application corresponding to the icon 405 located on the left side in Step s18. In the similar manner, if the sensor 200 detects the flick operation in the right direction performed by the finger on the detection object surface 15, the controller 100 selects the icon 405 located on the right side in the selection screen 600, and changes the color in the graphic 602 surrounding the icon 405 located on the right side in Step s17. Then, the controller 100 executes the application corresponding to the icon 405 located on the right side in Step s18.

The controller 100 can select the icon 405 in accordance with the direction of the slide operation performed by the finger on the detection object surface 15. If the sensor 200 detects the slide operation in the left direction performed by the finger on the detection object surface 15, the controller 100 selects the icon 405 located on the left side in the selection screen 600, and changes the color in the graphic 602 surrounding the icon 405 located on the left side in Step s17. Then, if the controller 100 specifies that the finger takes off from the detection object surface 15 based on the output signal from the sensor 200, the controller 100 executes the application corresponding to the icon 405 located on the left side in Step s18. In the similar manner, if the sensor 200 detects the slide operation in the right direction performed by the finger on the detection object surface 15, the controller 100 selects the icon 405 located on the right side in the selection screen 600, and changes the color in the graphic 602 surrounding the icon 405 located on the right side in Step s17. Then, if the controller 100 specifies that the finger takes off from the detection object surface 15 based on the output signal from the sensor 200, the controller 100 executes the application corresponding to the icon 405 located on the right side in Step s18.

In the meanwhile, if the controller 100 determines that the sensor 200 does not detect the movement operation performed by the finger on the detection object surface 15 but detects the finger taking off from the detection object surface 15, the controller 100 clears the selection screen 600 from the display surface 121 and displays the home screen 400 as shown in FIG. 10 described above. In Step s16, the display surface 121 may display the last display screen in the manner similar to Step s8. In such a case, the semi-transparent selection screen 600 is displayed to have an overlap with the last display screen.

As described above, in the present example, if the detection object surface 15 is pressed hard by the finger of the authorized user in the state where the display surface 121 is in the non-display state, the selection screen 600 is displayed. Then, if the movement operation is performed on the detection object surface 15 by the finger of the authorized user without taking off the finger from the detection object surface 15 after the detection object surface 15 is pressed hard with the finger, the icon 405 in the selection screen 600 is selected in accordance with the direction of the movement direction of the finger. Then, the application in accordance with the selected icon 405 is executed. Thus, the authorized user can provide the electronic apparatus 1 with the instruction on the application to be executed by pressing the detection object surface 15 hard with his/her finger, and subsequently moving his/her finger along the detection object surface 15 without taking off his/her finger from the detection object surface 15. Accordingly, the user can instruct the electronic apparatus 1 to execute the application with the simple operation in the state where the display surface 121 is in the non-display state. In other words, the user can instruct the electronic apparatus 1 to execute the application immediately in the state where the display surface 121 is in the non-display state. As a result, operability of the electronic apparatus 1 is improved.

In the present example, if the detection object surface 15 is pressed hard with the finger of the authorized user and the selection screen 600 is displayed, and then, the finger takes off from the detection object surface 15 without the movement operation of the finger on the detection object surface 15, the selection screen 600 is cleared. Thus, the authorized user can make the electronic apparatus 1 clear the selection screen 600 by pressing the detection object surface 15 hard with his/her finger and then taking off his/her finger from the detection object surface 15 without moving his/her finger along the detection object surface 15. Accordingly, the user can make the electronic apparatus 1 cancel the display of the selection screen 600 with the simple operation. As a result, the operability of the electronic apparatus 1 is improved.

As illustrated in FIG. 11, for example, in Step s14, the semi-transparent selection screen 600 is displayed to have an overlap with the screen displayed in Step s15 (the home screen 400, for example), thus the user can recognize the screen displayed after the display of the selection screen 600 is canceled, in advance. As a result, convenience of the electronic apparatus 1 is improved.

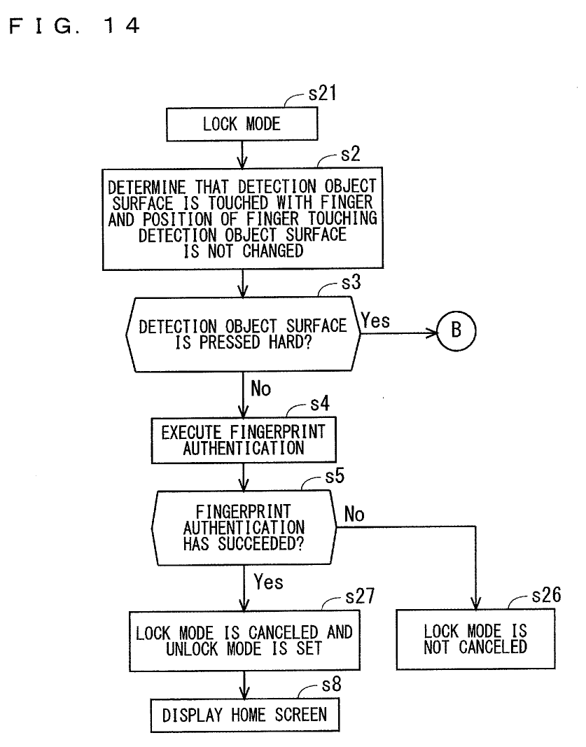

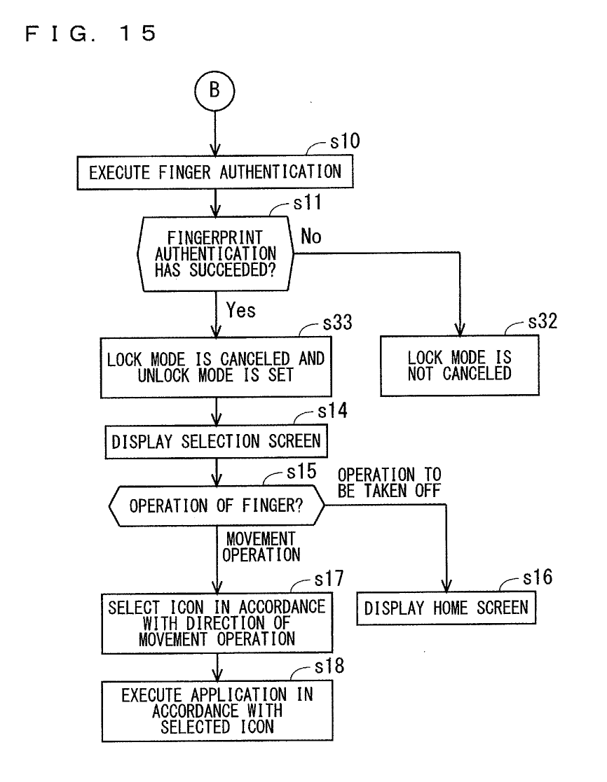

It is also applicable that in the state where the operation mode is the lock mode, when the predetermined operation is performed on the detection object surface 15, the electronic apparatus 1 cancels the lock mode to set the operation mode to the unlock mode. FIGS. 14 and 15 are flow charts illustrating one example of the operation of the electronic apparatus 1 in the above case. Each of the flow charts shown in FIGS. 14 and 15 has a configuration that Steps s1, s6, s7, s12, and s13 in the flow charts shown in FIGS. 7 and 8 described above are replaced with Steps s21, s26, s27, s32, and s33, respectively.

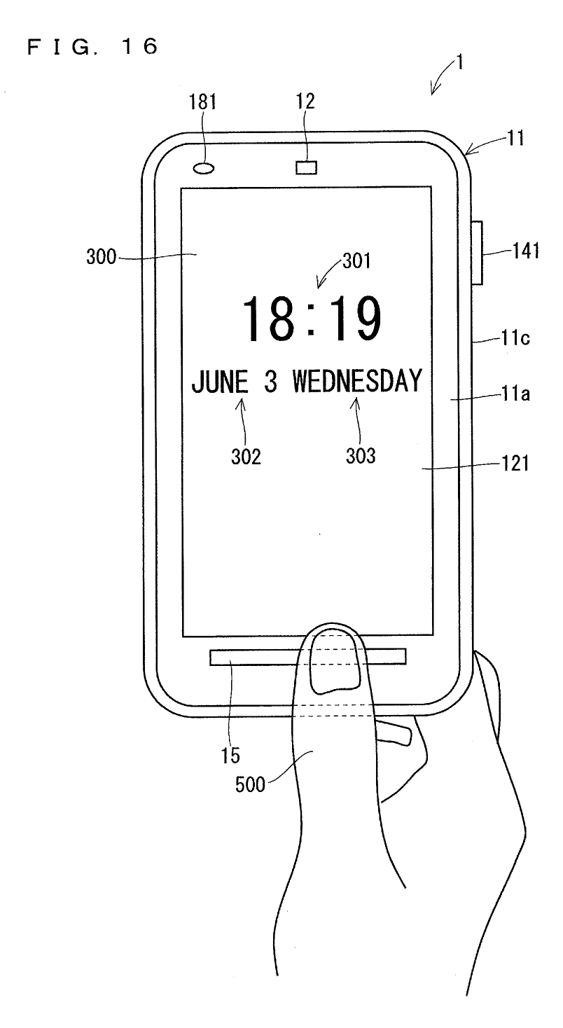

As shown in FIG. 14, in the case where the operation mode is the lock mode (Step s21), when the controller 100 determines that the detection object surface 15 is being touched with the finger and the position in the detection object surface 15 touched with the finger does not change based on the output signal from the sensor 200 in Step s2, the controller 100 executes Step s3. In other words, in the case where the display surface 121 displays the lock screen 300, when the controller 100 determines that the detection object surface 15 is being touched with the finger and the position in the detection object surface 15 touched with the finger does not change, the controller 100 executes Step s3. FIG. 16 is a drawing showing a state where the detection object surface 15 is touched with the finger 500 and the position in the detection object surface 15 touched with the finger 500 does not change when the operation mode is the lock mode.

If the determination is No in Step s3, the controller 100 executes Steps s4 and s5. If the determination is Yes in Step s5, the controller 100 cancels the lock mode to set the operation mode to the unlock mode in Step s27, and subsequently executes Step s8. Thus, the display in the display surface 121 is switched from the lock screen 300 to the home screen 400 (refer to FIG. 10). In the meanwhile, if the determination is No in Step s5, the controller 100 does not cancel the lock mode in Step s26. Thus, the display of the lock screen 300 is maintained in the display surface 121.

If the determination is Yes in Step s3, the controller 100 executes Steps s10 and s11 as shown in FIG. 15. If the determination is No in Step s11, the controller 100 does not cancel the lock mode in Step s32. In the meanwhile, if the determination is Yes in Step s11, the controller 100 cancels the lock mode to set the operation mode to the unlock mode in Step s33, and subsequently executes Step s14. Thus, the display in the display surface 121 is switched from the lock screen 300 to the selection screen 600 (refer to FIG. 11). Subsequently, the controller 100 executes Steps s15 to s17 in the similar manner.

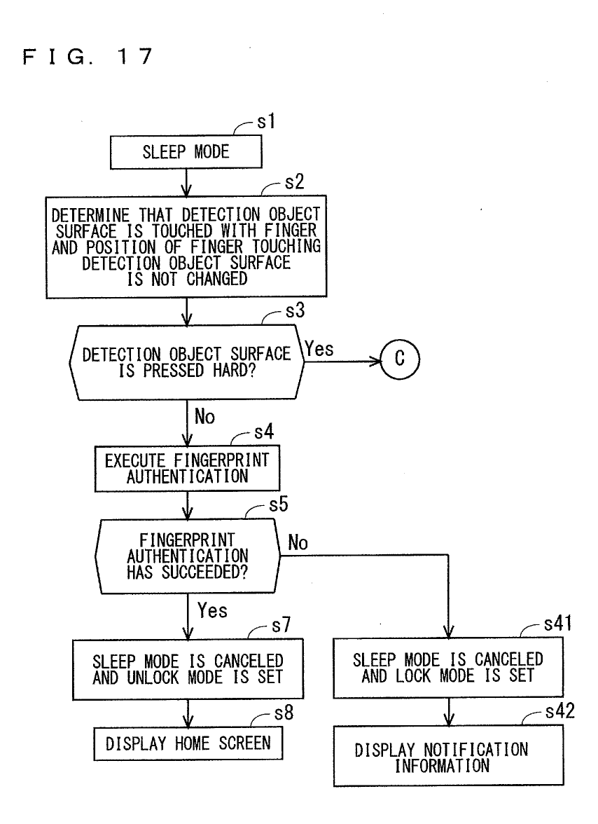

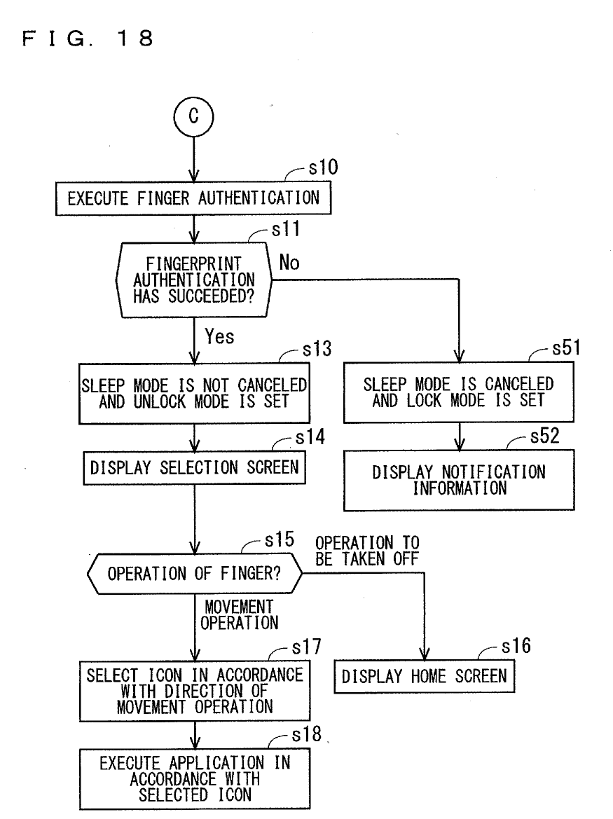

If the fingerprint authentication fails, the display surface 121 may display failure notification information for notifying the user that the fingerprint authentication has failed. FIGS. 17 and 18 are flow charts illustrating one example of the operation of the electronic apparatus 1 in the above case. Each of the flow charts shown in FIGS. 17 and 18 has a configuration that Steps s41 and s42 are executed instead of Step s6 shown in FIG. 7, and Steps s51 and s52 are executed instead of Step s12 shown in FIG. 8.

As shown in FIG. 17, if it is determined that the fingerprint authentication fails in Step s5, Steps s41 and s42 are sequentially executed. As shown in FIG. 18, if it is determined that the fingerprint authentication fails in Step s11, Steps s51 and s52 are sequentially executed.

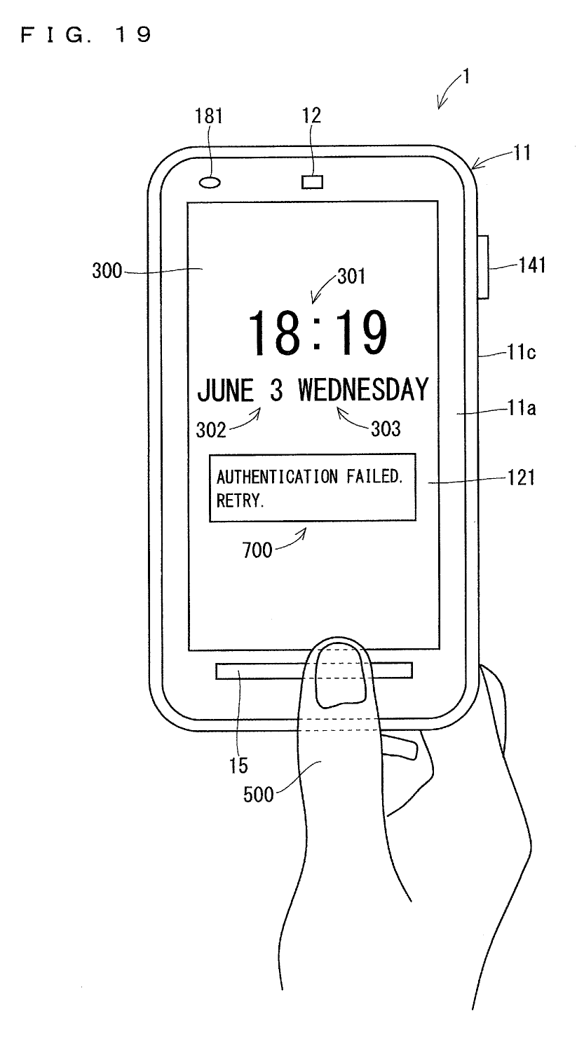

In each of Steps s41 and s51, the controller 100 cancels the sleep mode to set the operation mode to the lock mode. The lock screen 300 is thus displayed on the display surface 121. In each of Steps s42 and s52, the controller 100 displays, on the display surface 121, the failure notification information for notifying the user that the fingerprint authentication has failed. FIG. 19 is a drawing showing a display example of a failure notification information 700. The failure notification information 700 is shown on the lock screen 300, for example, as illustrated in FIG. 19.

When the user takes off the finger from the detection object surface 15, and touches the detection object surface 15 again with the finger after Steps s42 and s52, a series of processing shown in FIGS. 14 and 15 described above is executed because the current operation mode is the lock mode.

As described above, the failure notification information is displayed when the fingerprint authentication has failed in the example in FIGS. 17 and 18, thus the user can easily recognize that the fingerprint authentication has failed. As a result, the convenience of the electronic apparatus 1 is improved.

It is also applicable that in the flow charts shown in FIGS. 14 and 15, the failure notification information 700 is shown in the lock screen 300 after Step s26. The failure notification information 700 may also be shown in the lock screen 300 after Step s32.

The controller 100 may determine whether or not the sensor 200 detects the short press operation performed by the finger on the detection object surface 15 and whether or not the sensor 200 detects the long press operation performed by the finger on the detection object surface 15 instead of Steps s2 and s3 described above. In such a case, if the sensor 200 detects the short press operation performed by the finger on the detection object surface 15, the controller 100 executes Step s4. In the meanwhile, if the sensor 200 detects the long press operation performed by the finger on the detection object surface 15, the controller 100 executes Step s10. Thus, the authorized user can make the electronic apparatus 1 display the home screen 400 by performing the short press operation on the detection object surface 15 with his/her finger. The authorized user can make the electronic apparatus 1 display the selection screen 600 by performing the long press operation on the detection object surface 15 with his/her finger.

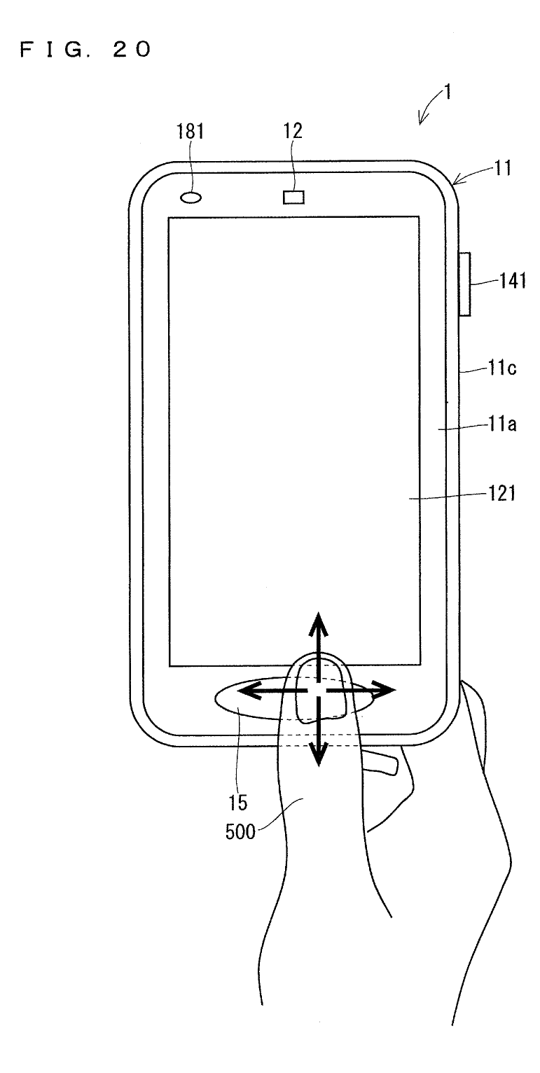

Although the sensor 200 detects the movement operation in the right and left direction in the example described above, the sensor 200 may detect the movement operation in a direction different from the right and left direction. FIG. 20 illustrates a front view showing one example of the external appearance of the electronic apparatus 1 in a case where the sensor 200 can detect the movement operation in the right and left direction and the up and down direction.

In the example in FIG. 20, the detection object surface 15 has an oval shape. A width of the detection object surface 15 in the up and down direction shown in FIG. 20 is larger than a width of the detection object surface 15 in the up and down direction shown in FIG. 1, for example. The user can perform the movement operation in the upper direction, the movement operation in the lower direction, the movement operation in the right direction, and the movement operation in the left direction performed on the detection object surface 15. The sensor 200 can detect the movement operation in the upper direction, the movement operation in the lower direction, the movement operation in the right direction, and the movement operation in the left direction performed on the detection object surface 15. The shape of the detection object surface 15 is not limited to the shapes shown in FIG. 20 and FIG. 1, for example.

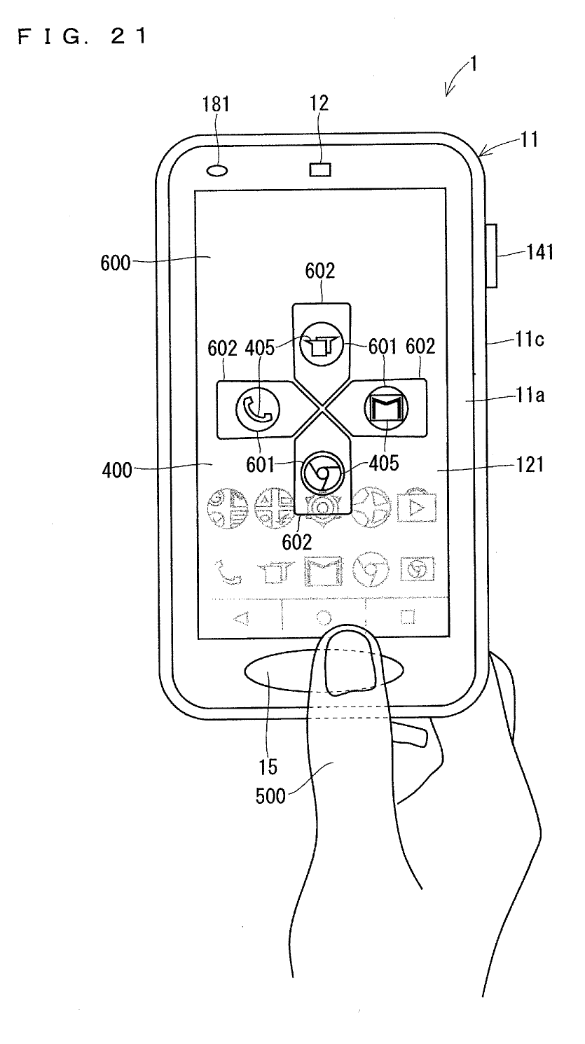

Although the selection screen 600 comprises the two icons 405 in the example described above, the selection screen 600 may comprise the three or more icons 405. FIG. 21 is a drawing showing one example of the selection screen 600 comprising the four icons 405. In the example in FIG. 21, the detection object surface 15 has a shape similar to the example in FIG. 20. In the example in FIG. 21, the sensor 200 can detect the movement operation in the upper direction, the movement operation in the lower direction, the movement operation in the right direction, and the movement operation in the left direction performed on the detection object surface 15.

In the selection screen 600 shown in FIG. 21, the four icons 405 are disposed around a center of the display surface 121. In the four icons 405, the two icons are arranged in the up and down direction, and the remaining two icons are arranged in the right and left direction. Each icon 405 is shown in the circle 601. The graphic 602 surrounds the icon 405 and the circle 601 surrounding the icon 405. The two graphics 602 which surround the two icons 405 arranged in the right and left direction, respectively, are disposed so that the longitudinal direction of the graphics 602 is directed along the right and left direction of the display surface 121 and corners of triangle chevrons each located on one end of the graphic 602 face each other. The two graphics 602 which surround the two icons 405 arranged in the up and down direction, respectively, are disposed so that the longitudinal direction of the graphics 602 is directed along the up and down direction of the display surface 121 and corners of triangle chevrons each located on one end of the graphic 602 face each other. In the manner similar to the above description, when the icon 405 is selected, the color in the graphic 602 surrounding the selected icon 405 changes. Thus, the user can recognize that the selected icon 405 is correctly selected.

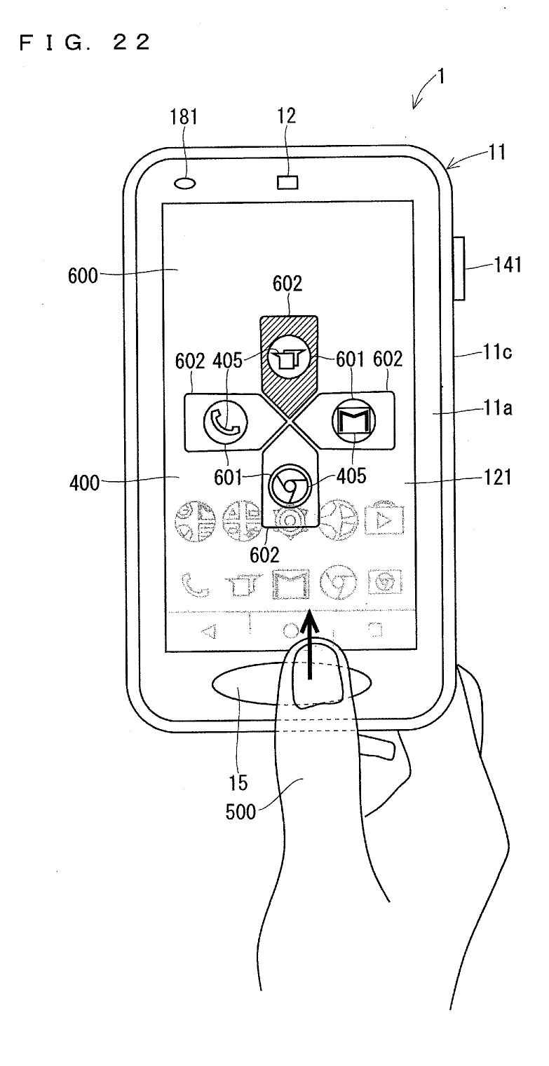

When the selection screen 600 shown in FIG. 21 is displayed, the controller 100 selects the icon 405 located on an upper side in the two icons 405 arranged in the up and down direction in the selection screen 600 in Step s17 described above in the case where the direction of the movement operation of the finger detected by the sensor 200 is the upper direction. FIG. 22 is a drawing showing one example of the state where the icon 405 located on the upper side is selected.

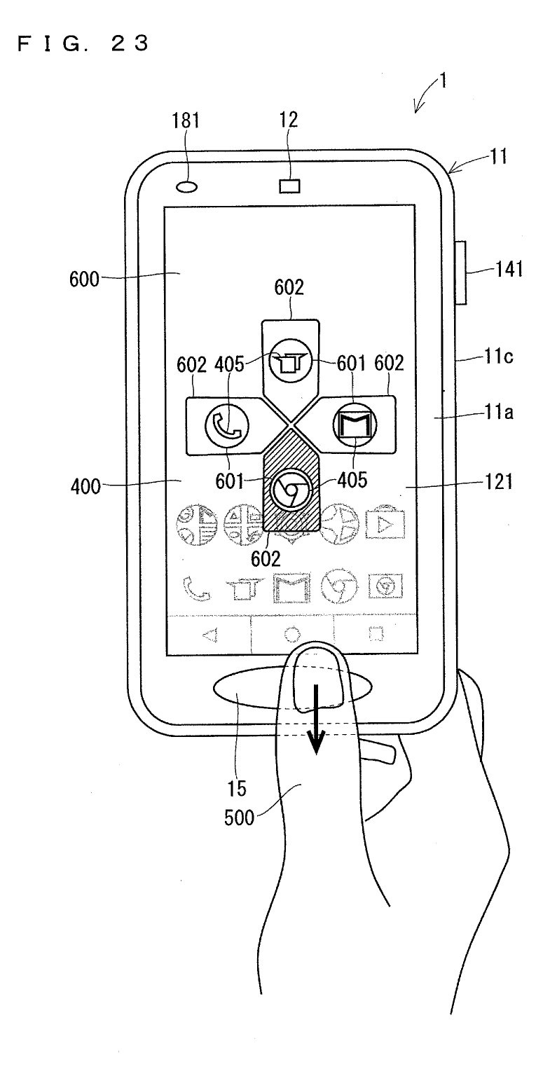

The controller 100 selects the icon 405 located on a lower side in the two icons 405 arranged in the up and down direction in the selection screen 600 in Step s17 in the case where the direction of the movement operation of the finger detected by the sensor 200 is the lower direction. FIG. 23 is a drawing showing one example of the state where the icon 405 located on the lower side is selected.

The operation of the controller 100 in the case where the direction of the movement operation of the finger detected by the sensor 200 is the left direction is similar to that in the above description. The operation of the controller 100 in the case where the direction of the movement operation of the finger detected by the sensor 200 is the right direction is similar to that in the above description. The operation of the controller 100 in the case where the controller 100 executes the application in accordance with the selected icon 405 is similar to that in the above description.

When the operation mode is the unlock mode, the controller 100 may change the display on the display surface 121 in accordance with the movement operation, detected by the sensor 200, of the finger performed on the detection object surface 15.

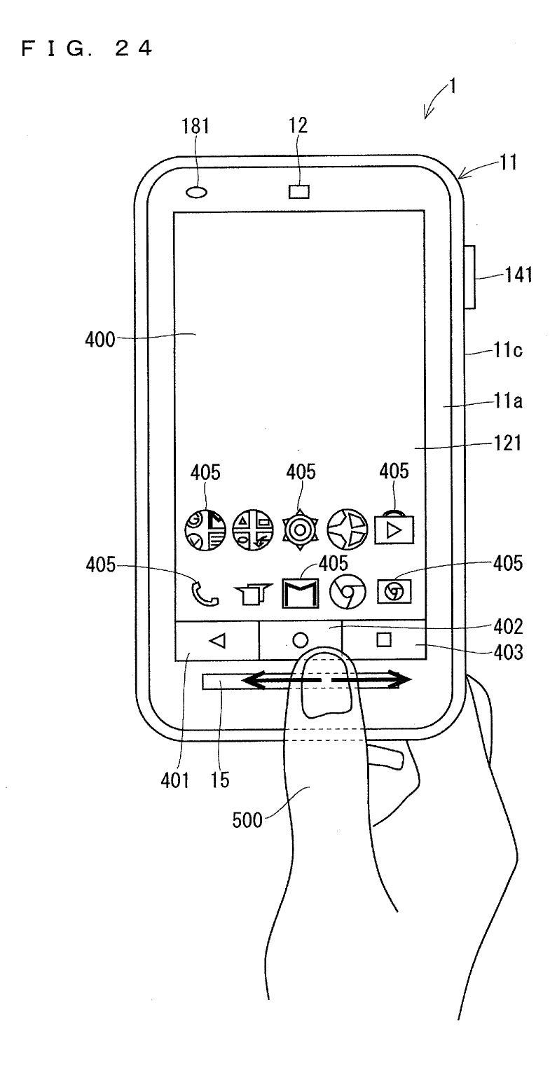

For example, when the sensor 200 detects the movement operation performed by the finger on the detection object surface 15 in the case where the display surface 121 displays the home screen 400, the controller 100 may display a page different from a page which is currently displayed on the display surface 121. For example, as shown in FIG. 24, when the user performs the movement operation with the finger 500 on the detection object surface 15 in the right and left direction, the sensor 200 detects the movement operation performed by the finger 500 on the detection object surface 15 in the right and left direction, and the controller 100 displays the page adjacent to the page which is currently displayed (for example, the page shown in FIG. 6). In such a case, when the sensor 200 detects the movement operation performed by the finger 500 on the detection object surface 15 in the left direction, the controller 100 displays the page on the right side of the page which is currently displayed. In the meanwhile, when the sensor 200 detects the movement operation performed by the finger 500 on the detection object surface 15 in the right direction, the controller 100 displays the page on the left side of the page which is currently displayed.

Thus, in the example in FIG. 24, the user can change the page in the home screen 400 displayed by the electronic apparatus 1 by performing the movement operation on the detection object surface 15 with the finger. Accordingly, when the operation mode is the sleep mode or the lock mode, the authorized user can change the page displayed by the electronic apparatus 1 by touching the detection object surface 15 to make the electronic apparatus 1 display the home screen 400, and subsequently performing the movement operation on the detection object surface 15 with the finger without taking off the finger from the detection object surface 15. Thus, the operability of the electronic apparatus 1 is improved.

When the movement operation performed by the finger on the detection object surface 15 is performed in the case where the display surface 121 displays a screen other than the home screen 400, the controller 100 may display the screen other than the screen which is currently displayed on the display surface 121. For example, when sensor 200 detects the movement operation performed by the finger on the detection object surface 15 in the case where a screen including a photographed image taken with the first camera 180, for example, is displayed, the controller 100 may display the screen including a photographed image different from the photographed image which is currently displayed on the display surface 121.

The controller 100 may scroll the screen displayed on the display surface 121 in accordance with the movement operation performed by the finger on the detection object surface 15 in the manner similar to the case of scrolling the screen displayed on the display surface 121 in accordance with the flick operation or the slide operation performed on the display surface 121.

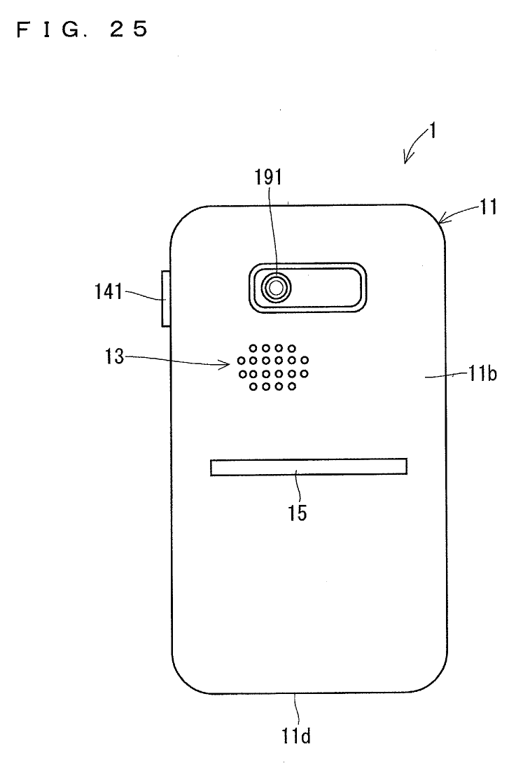

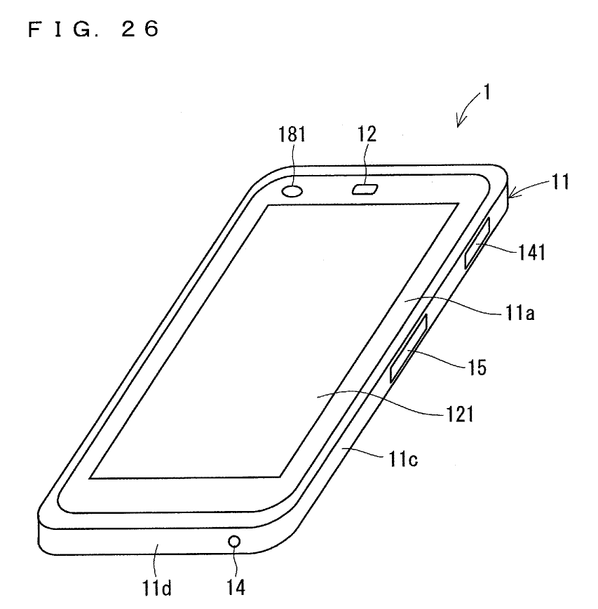

In the above example, the detection object surface 15 is located in the same surface as the surface which includes the display surface 121, however, the detection object surface 15 may be located in a surface different from the surface including the display surface 121. For example, the detection object surface 15 may be located in the rear surface 11b of the apparatus case 11 as shown in FIG. 25. The detection object surface 15 may be located in the side surface of the apparatus case 11. Specifically, the detection object surface 15 may be located in the side surface on the upper side, the side surface 11d on the lower side, the side surface 11c on the right side, or the side surface on the left side of the apparatus case 11. FIG. 26 is a drawing showing a state where the detection object surface 15 is located in the side surface 11c on the right side of the apparatus case 11.

When the operation mode is the normal mode, the controller 100 may change the operation mode to the sleep mode in accordance with the movement operation, detected by the sensor 200, of the finger performed on the detection object surface 15.

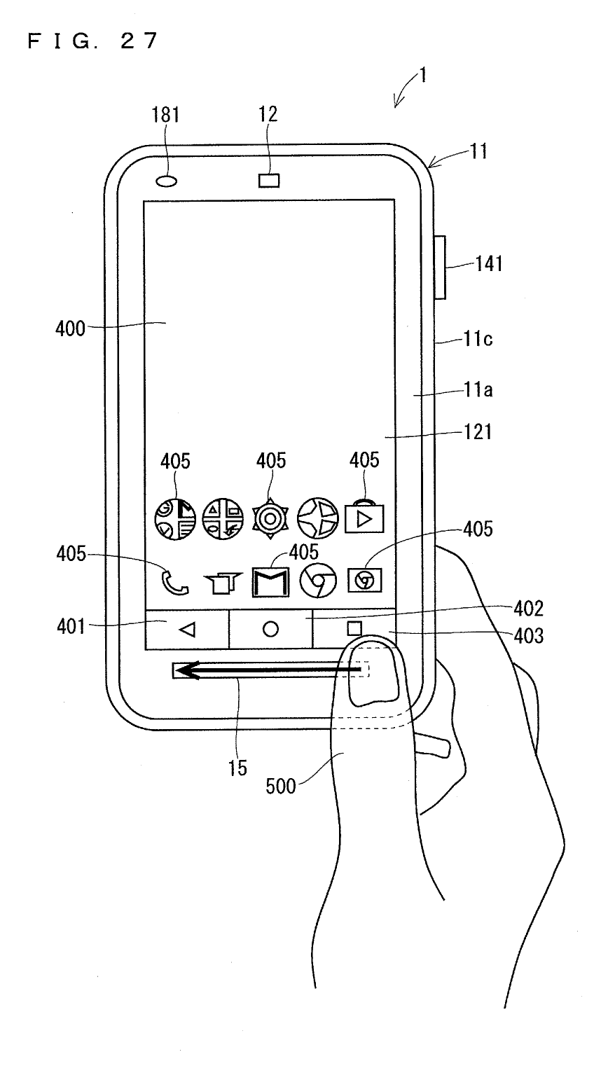

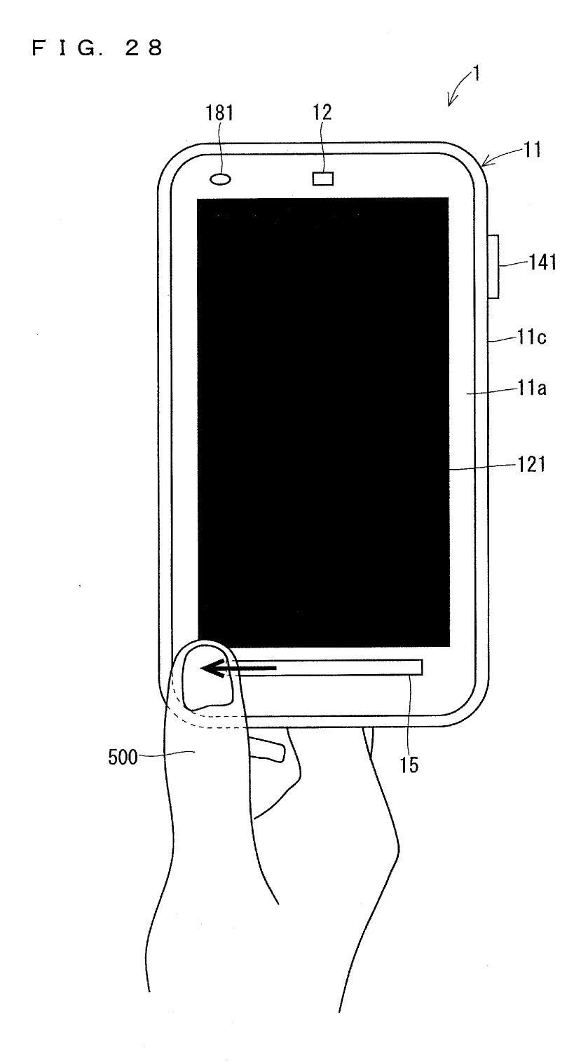

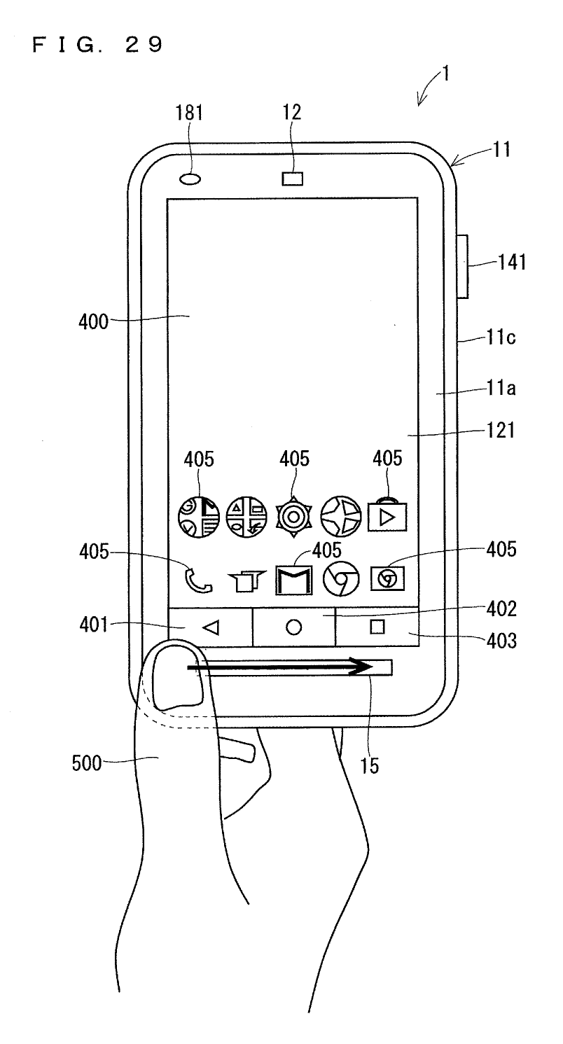

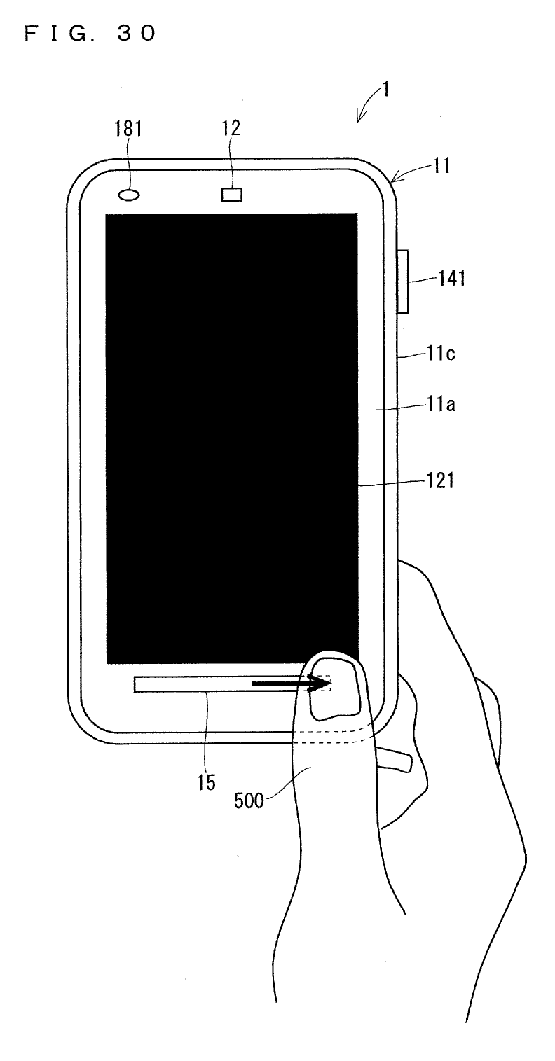

For example, in the case where the operation mode is the normal mode, if the sensor 200 detects the slide operation of the finger performed on the detection object surface 15 such that the finger moves from end to end on the detection object surface 15 in the right and left direction, the controller 100 sets the operation mode to the sleep mode to make the display surface 121 enter the non-display state. Specifically, if the sensor 200 detects that the finger of the user has moved from the right end to the left end of the detection object surface 15 in the state where the finger touches the detection object surface 15 as shown in FIG. 27, the controller 100 sets the operation mode to the sleep mode to make the display surface 121 enter the non-display state as shown in FIG. 28. If the sensor 200 detects that the finger of the user has moved from the left end to the right end of the detection object surface 15 in the state where the finger touches the detection object surface 15 as shown in FIG. 29, the controller 100 sets the operation mode to the sleep mode to make the display surface 121 enter the non-display state as shown in FIG. 30. The ends of the detection object surface 15 mean the ends of the detection object surface 15 in the right and left direction hereinafter if not otherwise specified.

If the user starts the movement of the finger from one end of the detection object surface 15 while touching the detection object surface 15 with the finger and takes off the finger from the detection object surface 15 before the finger reaches the other end of the detection object surface 15, the controller 100 maintains the normal mode.

In the case where the operation mode is the normal mode, the controller 100 may change the operation mode to the sleep mode if the user performs the flick operation with the finger on the detection object surface 15 from the end of the detection object surface 15. For example, if the sensor 200 detects the flick operation of the finger from the right end of the detection object surface 15 as a starting point toward the left end, the controller 100 changes the operation mode from the normal mode to the sleep mode. If the sensor 200 detects the flick operation of the finger from the left end of the detection object surface 15 as a starting point toward the right end, the controller 100 changes the operation mode from the normal mode to the sleep mode.

As described above, since the user can operate the electronic apparatus 1 so that the display surface 121 enters the non-display state by performing the movement operation of the finger on the detection object surface 15, the user can operate the electronic apparatus 1 so that the display surface 121 enters the non-display state with the simple operation on the electronic apparatus 1. Thus, the operability of the electronic apparatus 1 is improved. If the sensor 200 detects the movement operation of the finger in a direction other than the right and left direction performed on the detection object surface 15, the electronic apparatus 1 may make the display surface 121 enter the non-display state in accordance with the movement operation. For example, the electronic apparatus 1 may make the display surface 121 enter the non-display state in accordance with the movement of the finger in the up and down direction performed on the detection object surface 15.

The operation of the finger of the user moving from end to end of the detection object surface 15 in the right and left direction in the state where the finger touches the detection object surface 15 is referred to as the “slide operation of the finger from end to end” in some cases hereinafter. The operation of the finger of the user moving from the left end to the right end of the detection object surface 15 in the state where the finger touches the detection object surface 15 is referred to as the “slide operation of the finger from end to end in the left direction” in some cases. The operation of the finger of the user moving from the right end to the left end of the detection object surface 15 in the state where the finger touches the detection object surface 15 is referred to as the “slide operation of the finger from end to end in the right direction” in some cases. The flick operation of the finger from one end of the detection object surface 15 as a starting point toward the other end is referred to as the “flick operation of the finger from the end” in some cases. The flick operation of the finger from the right end of the detection object surface 15 as a starting point toward the left end is referred to as the “flick operation of the finger from the end in the left direction” in some cases. The flick operation of the finger from the left end of the detection object surface 15 as a starting point toward the right end is referred to as the “flick operation of the finger from the end in the right direction” in some cases. The slide operation of the finger from end to end and the flick operation of the finger from the end are collectively referred to as the “movement operation of the finger from the end” in some cases.

The display surface 121 displays the home screen 400 in the example in FIGS. 27 to 30, however, even when the display surface 121 displays the screen other than the home screen, the user can make the electronic apparatus 1 set the operation mode to the sleep mode by performing the slide operation of the finger from end to end or the flick operation of the finger from the end on the detection object surface 15. For example, when the display surface 121 displays the lock screen 300, the user can make the electronic apparatus 1 set the operation mode to the sleep mode by performing the slide operation of the finger from end to end or the flick operation of the finger from the end on the detection object surface 15.

In the case where the operation mode is the sleep mode, if the sensor 200 detects the movement operation of the finger from the end performed on the detection object surface 15, the controller 100 may set the operation mode to the normal mode to make the display surface 121 enter the display state.

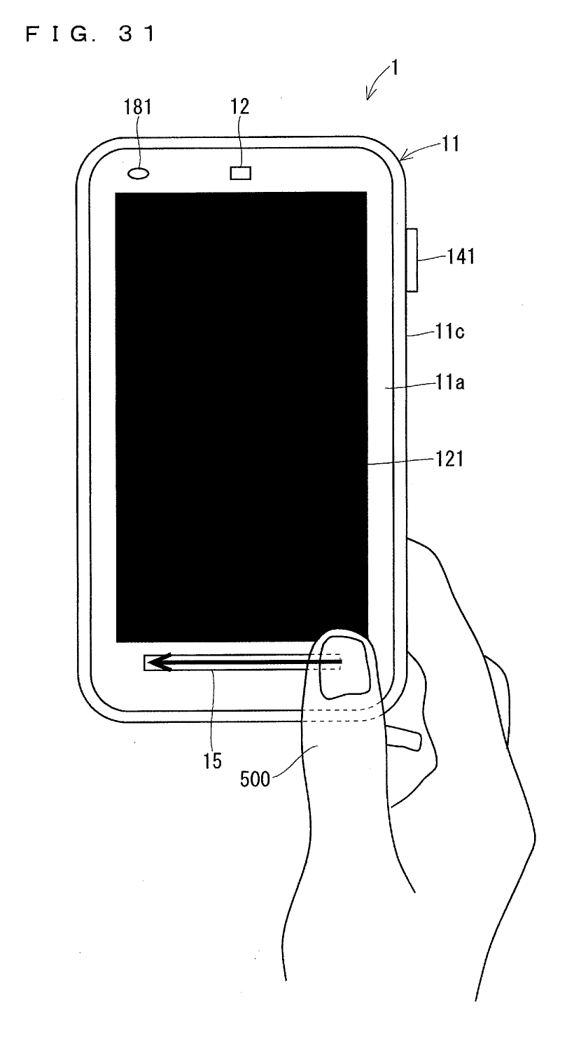

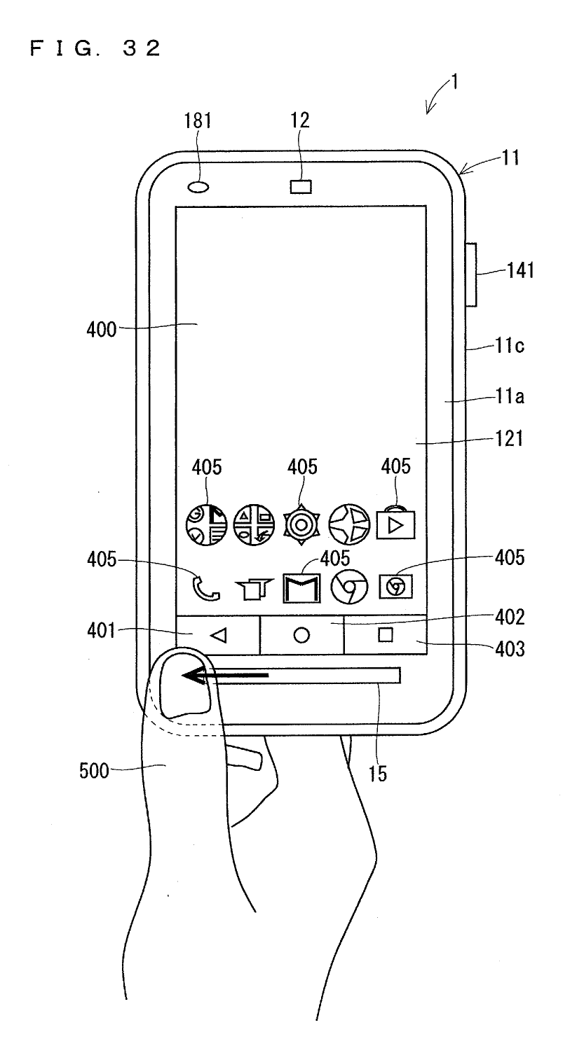

For example, in the case where the operation mode is the sleep mode, when the sensor 200 detects the slide operation of the finger from end to end in the left direction as shown in FIG. 31, the controller 100 sets the operation mode to the normal mode to make the display surface 121 enter the display state as shown in FIG. 32. In the case where the operation mode is the sleep mode, when the sensor 200 detects the slide operation of the finger from end to end in the right direction, the controller 100 sets the operation mode to the normal mode to make the display surface 121 enter the display state. In the case where the operation mode is the sleep mode, if the user starts the movement of the finger from one end of the detection object surface 15 while touching the detection object surface 15 with the finger and takes off the finger from the detection object surface 15 before the finger reaches the other end of the detection object surface 15, the controller 100 maintains the sleep mode. That is to say, in the case where the operation mode is the sleep mode, if the user stops halfway the slide operation of the finger from the end to end performed on the detection object surface 15 and then takes off the finger from the detection object surface 15, the controller 100 maintains the sleep mode.

In the case where the operation mode is the sleep mode, when the sensor 200 detects the flick operation of the finger from the end in the left direction, the controller 100 sets the operation mode to the normal mode. In the case where the operation mode is the sleep mode, when the sensor 200 detects the flick operation of the finger from the end in the right direction, the controller 100 sets the operation mode to the normal mode. If the sensor 200 detects the movement operation of the finger in a direction other than the right and left direction performed on the detection object surface 15, the electronic apparatus 1 may change the operation mode from the sleep mode to the normal mode in accordance with the movement operation. For example, the electronic apparatus 1 may change the operation mode from the sleep mode to the normal mode in accordance with the movement of the finger in the up and down direction performed on the detection object surface 15.

When the controller 100 changes the operation mode from the sleep mode to the normal mode in the case where the sensor 200 detects the movement operation of the finger from the end performed on the detection object surface 15, the controller 100 may perform the fingerprint authentication halfway through the movement operation.

For example, in the case where the user performs the slide operation of the finger from end to end, if the finger of the user starts the movement from the one end to the other end of the detection object surface 15 while touching the detection object surface 15, the controller 100 performs the fingerprint authentication based on the fingerprint detected by the sensor 200. Alternatively, the controller 100 may perform the fingerprint authentication based on the fingerprint detected by the sensor 200 once the finger of the user touches the detection object surface 15. If the fingerprint authentication has succeeded and the finger moves from the one end to the other end of the detection object surface 15, the controller 100 changes the operation mode from the sleep mode to the normal mode. In the meanwhile, if the fingerprint authentication has failed, the controller 100 maintains the sleep mode even if the finger moves from the one end to the other end of the detection object surface 15.

In the case where the user performs the flick operation of the finger from the end, the controller 100 performs the fingerprint authentication based on the fingerprint detected by the sensor 200 once the finger of the user touches the detection object surface 15. If the fingerprint authentication has succeeded and the flick operation of the finger from the end is performed on the detection object surface 15, the controller 100 changes the operation mode from the sleep mode to the normal mode. In the meanwhile, if the fingerprint authentication has failed, the controller 100 maintains the sleep mode even if the flick operation of the finger from the end is performed on the detection object surface 15.

When the controller 100 changes the operation mode from the normal mode to the sleep mode in the case where the sensor 200 detects the movement operation of the finger from the end performed on the detection object surface 15, it is also applicable that the controller 100 displays a predetermined screen on the display surface 121 so that the predetermined screen gradually appears in accordance with the movement of the finger detected when the sensor 200 detects the movement operation, and subsequently sets the operation mode to the sleep mode. The predetermined screen is referred to as the “specified screen” hereinafter.

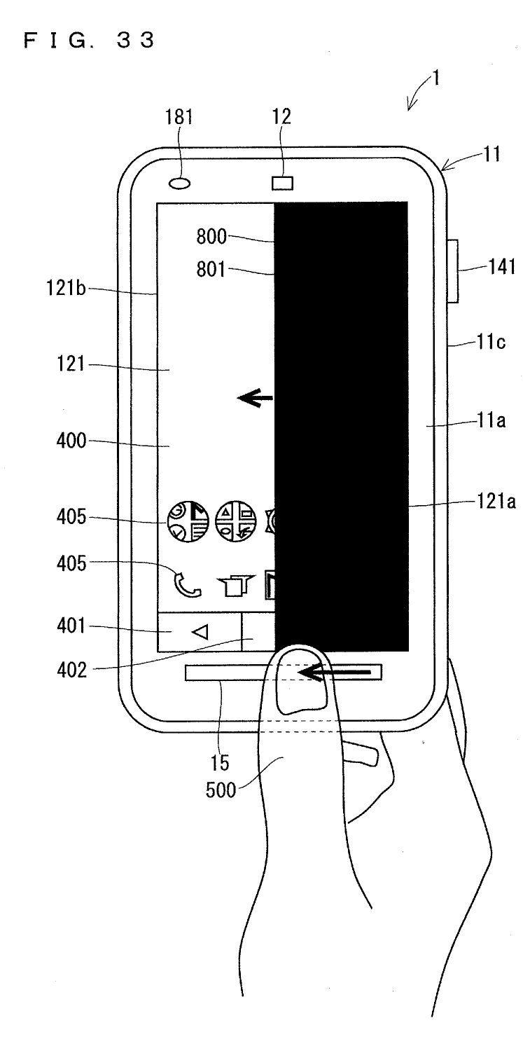

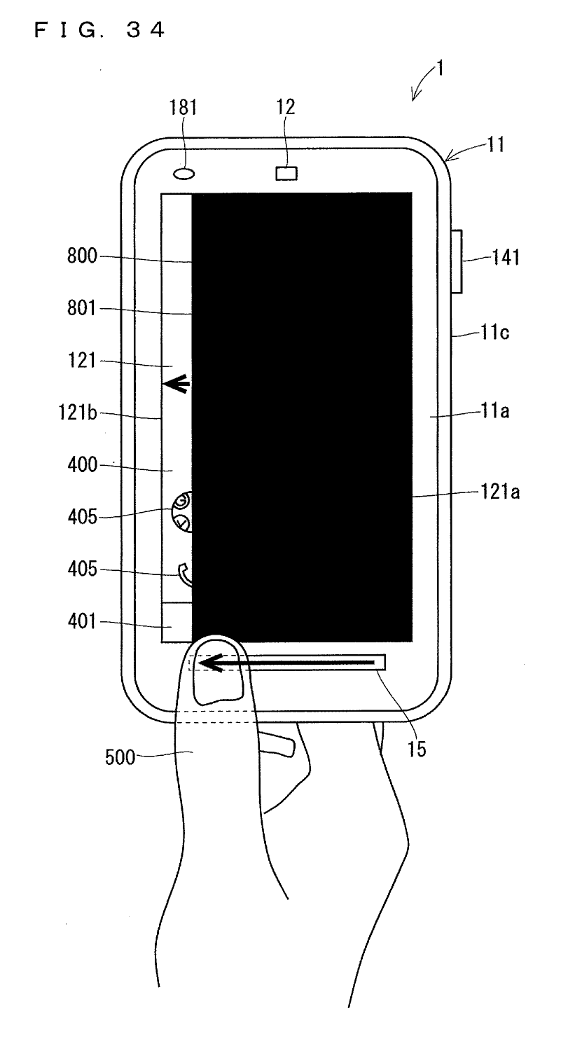

FIGS. 33 and 34 are drawings each showing one example of a state where a specified screen 800 appears in the display surface 121 so that the specified screen 800 gradually appears in accordance with the movement of the finger 500 detected when the sensor 200 detects the slide operation of the finger from end to end. In the example in FIGS. 33 and 34, the specified screen 800 is a non-transparent black screen. The specified screen 800 may be a screen other than the black screen. FIGS. 33 and 34 show one example of a case where the slide operation of the finger from end to end in the left direction is performed on the detection object surface 15 when the display surface 121 displays the home screen 400. FIG. 33 shows the specified screen 800 in a case where the finger 500 moves to a central part in the right and left direction of the detection object surface 15. FIG. 34 shows the specified screen 800 in a case where the finger 500 moves close to the left end of the detection object surface 15. When the display surface 121 displays the whole specified screen 800, a size of the specified screen 800 being displayed is the same as that of the display surface 121, for example.

When the slide operation of the finger 500 from end to end performed on the detection object surface 15 starts, the specified screen 800 appears from the end of the display surface 121 on the same side as the end from which the movement of the finger 500 starts in the detection object surface 15. Since the movement of the finger 500 starts from the right end of the detection object surface 15 in the example in FIGS. 33 and 34, the specified screen 800 appears from a right end 121a of the display surface 121. Then, the specified screen 800 gradually appears in the display surface 121 in accordance with the movement of the finger 500 until the slide operation of the finger 500 from end to end is completed. For example, as shown in FIGS. 33 and 34, the specified screen 800 gradually appears in the display surface 121 so that a left end 801 of the specified screen 800 gradually moves in the left direction in the display surface 121 in accordance with the movement of the finger 500 in the left direction until the slide operation of the finger 500 from end to end is completed. For example, if the finger 500 moves from the right end of the detection object surface 15 to the left by X % (0≤X≤100) of a length of the detection object surface 15 in the right and left direction, the left end 801 of the specified screen 800 moves from the right end 121a to the left by X % of the length of the display surface 121 in the right and left direction. When the left end 801 of the specified screen 800 reaches the left end 121b of the display surface 121, that is to say, when the display surface 121 displays the whole specified screen 800, the operation mode is set to the sleep mode. Accordingly, the backlight 123 is turned off, and the display surface 121 enters the non-display state. The specified screen 800 is displayed to have an overlap with the screen which has been displayed on the displayed surface 121 immediately before the specified screen 800 is displayed. In the example in FIGS. 33 and 34, the specified screen 800 has an overlap with the home screen 400.

In the similar manner, when the slide operation of the finger 500 from end to end performed on the detection object surface 15 starts, the specified screen 800 appears from the left end 121b of the display surface 121. Then, the specified screen 800 gradually appears in the display surface 121 so that the right end of the specified screen 800 gradually moves in the right direction in the display surface 121 in accordance with the movement of the finger 500 in the right direction until the slide operation of the finger 500 from end to end in the right direction is completed. When the right end of the specified screen 800 reaches the right end 121a of the display surface 121, the operation mode is set to the sleep mode.

If the user stops halfway the slide operation of the finger from the end to end performed on the detection object surface 15 and then takes off the finger from the detection object surface 15, the controller 100 maintains the normal mode and clears the display of the specified screen 800. Thus, the whole screen (the home screen 400 in the example in FIGS. 33 and 34) under the specified screen 800 is displayed.

When the flick operation of the finger from the end is performed on the detection object surface 15, in the manner similar to the above description, the specified screen 800 appears from the end of the display surface 121 on the same side as the end from which the movement of the finger starts in the detection object surface 15. Then, the specified screen 800 gradually appears in the display surface 121 in accordance with the movement of the finger on the detection object surface 15. For example, when the flick operation of the finger from the end in the left direction is performed on the detection object surface 15, the specified screen 800 which has appeared from the right end 121a of the display surface 121 gradually appears in the display surface 121 so that the left end 801 moves to the left end 121b of the display surface 121 at a speed corresponding to a speed of the flick operation. Specifically, as the speed of the flick operation increases, the speed of the movement of the left end 801 of the specified screen 800 toward the left ends 121b increases. In the similar manner, when the flick operation of the finger from the end in the right direction is performed on the detection object surface 15, the specified screen 800 which has appeared from the left end 121b of the display surface 121 gradually appears in the display surface 121 so that the right end of the specified screen 800 moves to the right end 121a of the display surface 121 at a speed corresponding to a speed of the flick operation.

As described above, the specified screen is displayed to gradually appear in accordance with the movement of the finger detected when the sensor 200 detects the movement operation of the finger from the end, thus the user easily recognize that his/her operation performed on the detection object surface 15 is received by the electronic apparatus 1. Accordingly, the user easily recognizes an erroneous operation, and the convenience of the electronic apparatus 1 is improved. Particularly, if the specified screen is the black screen, the user easily recognizes that the user performs the operation for instructing the electronic apparatus 1 to make the display surface 121 enter the non-display state. If the sensor 200 detects the movement operation of the finger in the direction other than the right and left direction performed on the detection object surface 15, the specified screen may be displayed to gradually appear in accordance with the movement of the finger when the movement operation of the finger in the direction other than the right and left direction is performed on the detection object surface 15. For example, the specified screen may be displayed to gradually appear in accordance with the movement of the finger in the up and down direction performed on the detection object surface 15.

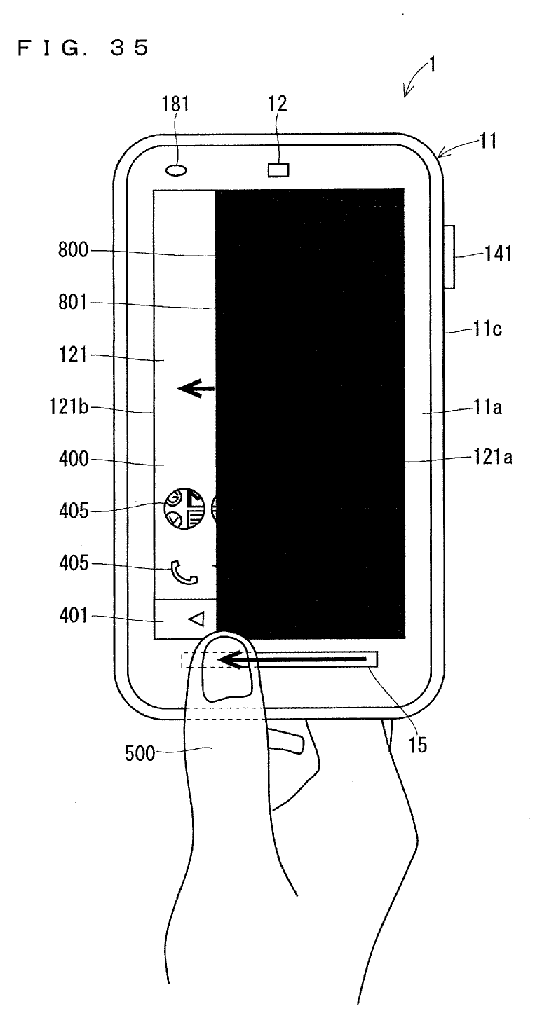

In the controller 100, a semi-transparent screen may be used as the specified screen 800 as shown in FIG. 35. If the specified screen 800 is semi-transparent, the user can recognize the whole screen under the specified screen 800, that is to say, the whole screen which has been displayed immediately before the specified screen 800 is displayed. In the example in FIG. 35, the semi-transparent black screen is displayed as the specified screen 800.

If the specified screen 800 is the semi-transparent screen, a degree of transparency of the specified screen 800 may be changed in the specified screen 800. For example, if the movement operation of the finger in the left direction from the end is performed on the detection object surface 15, the degree of transparency of the specified screen 800 may be reduced from the left end 801 of the specified screen 800 toward the right end 121a of the display surface 121. If the movement operation of the finger in the right direction from the end is performed on the detection object surface 15, the degree of transparency of the specified screen 800 may be reduced from the right end of the specified screen 800 toward the left end 121b of the display surface 121.

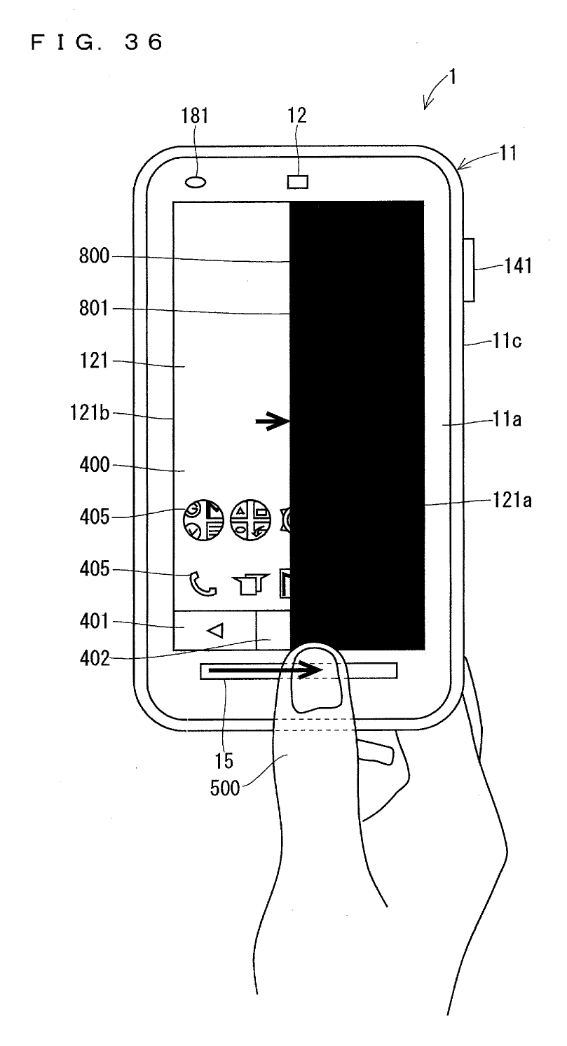

If the movement operation of the finger in the right direction from the end is performed on the detection object surface 15 in the case where the operation mode is the sleep mode, the controller 100 may perform, on the display surface 121, a display opposite to the display on the display surface 121 when the movement operation of the finger in the left direction from the end is performed on the detection object surface 15 in the case where the operation mode is the normal mode. Specifically, if the sensor 200 detects that the left end of the detection object surface 15 is touched with the finger, the controller 100 tentatively changes the operation mode from the sleep mode to the normal mode. Then, the controller 100 displays the whole specified screen 800 on the display surface 121. At this time, the controller 100 displays the specified screen 800 to have an overlap with the last display screen which has been displayed immediately before the operation mode is set to the sleep mode. If the specified screen 800 is the non-transparent screen, the screen under the specified screen 800 is not visually recognized by the user. If the specified screen 800 is the black screen, the display surface 121 changes little in appearance even if the specified screen 800 is displayed. Then, if the sensor 200 detects the finger starting moving to the right end on the detection object surface 15, the controller 100 gradually moves the left end 801 of the specified screen 800 from the left end 121b toward the right end 121a of the display surface 121 in accordance with the movement of the finger 500 in the right direction detected by the sensor 200. Thus, the specified screen 800 gradually disappears from the display surface 121, the right end of the specified screen 800 disappearing first. The movement of the left end 801 of the specified screen 800 in accordance with the movement of the finger 500 in the right direction detected by the sensor 200 is similar to the movement of the right end of the specified screen 800 in accordance with the movement of the finger 500 in the right direction detected by the sensor 200 in the case where the operation mode is changed from the normal mode to the sleep mode. A part of the screen under the specified screen 800, that is to say, a part of the screen of the last display screen which has been displayed immediately before the operation mode is set to the sleep mode (the home screen 400 in the example in FIG. 36) is displayed in a region where the specified screen 800 is not displayed in the display surface 121. When the left end 801 of the specified screen 800 reaches the right end 121a of the display surface 121 and the specified screen 800 is cleared, the controller 100 determines the operation mode to be the normal mode. Thus, the whole region (the home screen 400 in the example in FIG. 36) of the last display screen is displayed on the display surface 121.

In the similar manner, if the movement operation of the finger in the left direction from the end is performed on the detection object surface 15 in the case where the operation mode is the sleep mode, the controller 100 may perform, on the display surface 121, a display opposite to the display on the display surface 121 when the movement operation of the finger in the right direction from the end is performed on the detection object surface 15 in the case where the operation mode is the normal mode. Also in the case where the movement operation in the direction other than the right and left direction is performed on the detection object surface 15, the electronic apparatus 1 may change the display on the display surface 121 in the similar manner.

In the case where the slide operation of the finger from end to end is performed on the detection object surface 15, if the slide operation is halfway stopped and the finger takes off from the detection object surface 15, the controller 100 cancels the normal mode which is tentatively set to return the operation mode to the sleep mode.

The specified screen 800 displayed when the movement operation of the finger from the end is performed on the detection object surface 15 in the case where the operation mode is the sleep mode may be the non-transparent screen or the semi-transparent screen. If the specified screen 800 is the semi-transparent screen, the degree of transparency of the specified screen 800 may be changed in the specified screen 800.

In the case where the display panel 122 is the self-luminous display panel such as the organic EL panel, the controller 100 may gradually clear the display on the display surface 121 to set the display surface 121 to the non-display state in accordance with the movement of the finger 500 detected when the sensor 200 detects the movement operation of the finger from the end in the state where the operation mode is the normal mode.

For example, when the movement operation of the finger from the end is started on the detection object surface 15, the controller 100 sequentially turns off the display in accordance with the movement of the finger 500 from one end of the display surface 121 on the same side as the end from which the movement of the finger 500 starts on the detection object surface 15 toward the other end. For example, when the movement operation of the finger in the left direction from the end is started on the detection object surface 15, the controller 100 sequentially turns off the display in accordance with the movement of the finger 500 in the left direction from the right end 121a toward the left end 121b of the display surface 121. For example, in the case where the user performs the slide operation of the finger in the left direction from end to end, if the finger moves from the right end of the detection object surface 15 to the left by X % of the length of the detection object surface 15 in the right and left direction, the display of the display surface 121 is turned off from the right end 121a by X % of the length of the display surface 121 in the right and left direction. In such a case, the appearance of the display surface 121 is similar to the case of displaying the black screen as the specified screen 800 as shown in FIGS. 33 and 34. If the user performs the flick operation of the finger in the left direction from the end, the controller 100 sequentially clear the display on the display surface 121 from the right end 121a toward the left end 121b at a speed corresponding to the speed of the flick operation. When the display on the display surface 121 is totally turned off, the operation mode is set to the sleep mode. In the similar manner, if the movement operation of the finger in the right direction from the end is started on the detection object surface 15, the controller 100 sequentially turns off the display from the left end 121b toward the right end 121a of the display surface 121 in accordance with the movement of the finger 500 in the right direction.

As described above, even if the display on the display surface 121 is gradually cleared to set the display surface 121 to the non-display state in accordance with the movement of the finger detected when the sensor 200 detects the movement operation of the finger from the end in the case where the operation mode is the normal mode, the user easily recognizes that the user performs the operation for instructing the electronic apparatus 1 to make the display surface 121 enter the non-display state. Thus, the convenience of the electronic apparatus 1 is improved. Also in the case where the movement operation of the finger in the direction other than the right and left direction is performed on the detection object surface 15, the electronic apparatus 1 may gradually clear the display on the display surface 121 to set the display surface 121 to the non-display state in accordance with the movement of the finger in the similar manner. The processing of gradually clearing the display on the display surface 121 in accordance with the movement of the finger when the movement operation of the finger from the end is performed on the detection object surface 15 in the case where the operation mode is the normal mode is referred to as the “gradual clearing processing” in some cases.

If the movement operation of the finger in the right direction from the end is performed on the detection object surface 15 in the case where the operation mode is the sleep mode, the controller 100 of the electronic apparatus 1 comprising the self-luminous display panel as the display panel 122 may perform, on the display surface 121, a display opposite to the case of performing the gradual clearing processing when the movement operation of the finger in the left direction from the end is performed on the detection object surface 15 in the case where the operation mode is the normal mode. In such a case, if the movement operation of the finger in the right direction from the end is performed on the detection object surface 15, the controller 100 tentatively changes the operation mode from the sleep mode to the normal mode. Then, the controller 100 gradually turns on the display on the display surface 121 from the left end 121b toward the right end 121a in accordance with the movement of the finger in the right direction to sequentially display the last display screen from the left end. The appearance of the display surface 121 at this time is similar to the example in the FIG. 36 described above. The controller 100 determines the operation mode to the normal mode upon turning on the whole display surface 121. Thus, the whole region of the last display screen is displayed on the display surface 121. In the similar manner, if the movement operation of the finger in the left direction from the end is performed on the detection object surface 15 in the case where the operation mode is the sleep mode, the controller 100 may perform, on the display surface 121, a display opposite to the case of performing the gradual clearing processing when the movement operation of the finger in the right direction from the end is performed on the detection object surface 15 in the case where the operation mode is the normal mode. Also in the case where the movement operation of the finger in the direction other than the right and left direction is performed on the detection object surface 15, the electronic apparatus 1 may control the display on the display surface 121 in the similar manner.

In the case where the slide operation of the finger from end to end is performed on the detection object surface 15, if the slide operation is halfway stopped and the finger takes off from the detection object surface 15, the controller 100 cancels the normal mode which is tentatively set and returns the operation mode to the sleep mode, thereby turning off the whole display on the display surface 121.

As described above, since the electronic apparatus 1 comprises the sensor 200 detecting the operation of the finger performed on the detection object surface 15 along the detection object surface 15, the user can perform the input to the electronic apparatus 1 by operating the detection object surface 15. Thus, the operability of the electronic apparatus 1 is improved.

The sensor 200 can detect the fingerprint of the finger touching the detection object surface 15, and can detect the operation of the finger performed on the detection object surface 15 along the detection object surface 15. Thus, the electronic apparatus 1 can detect the fingerprint and the operation using the same region located in the surface thereof. Thus, the surface of the electronic apparatus 1 can be effectively used.

If the detection object surface 15 is located in the same surface as the surface where display surface 121 is located in the plurality of surfaces of the electronic apparatus 1 (the front surface in the example in FIG. 1, for example) as shown in FIG. 1, for example, the operability of the detection object surface 15 is improved. For example, if the user operates the detection object surface 15 in a state where the electronic apparatus 1 is disposed on a desk so that the display surface 121 is directed upward, the detection object surface 15 is also directed upward, thus the user easily operates the detection object surface 15. Even in a case where a cover exposing the display surface 121 is attached to the electronic apparatus 1, the detection object surface 15 is located in the same surface as the display surface 121, thus the user easily operates the detection object surface 15. If the electronic apparatus 1 detects the operation performed on the display surface 121 as the present example, the user easily performs a switching between the operation on the display surface 121 and the operation on the detection object surface 15, since the display surface 121 and the detection object surface 15 are located in the same surface. If the user operates the front surface of the electronic apparatus 1 with both hands with the electronic apparatus 1 in the both hands, the user easily operates both the display surface 121 and the detection object surface 15, since both the display surface 121 and the detection object surface 15 are located in the front surface of the electronic apparatus 1. For example, the user can operate, immediately after operating the display surface 121 with one hand, the detection object surface 15 with the other hand. The user can operate, immediately after operating the detection object surface 15 with one hand, the display surface 12 with the other hand.

Although the electronic apparatus 1 is a mobile phone, such as a smartphone, in the above-mentioned examples, the electronic apparatus 1 may be other types of electronic apparatuses. The electronic apparatus 1 may be a tablet terminal, a personal computer, and a wearable apparatus, for example. The wearable apparatus used as the electronic apparatus 1 may be an apparatus wearable on the wrist, such as a wristband apparatus and a wristwatch apparatus, an apparatus wearable on the head, such as a headband apparatus and an eyeglasses apparatus, and an apparatus wearable on the body, such as a clothing apparatus.

As described above, in the case where the electronic apparatus 1 can specify that the detection object surface 15 is touched by the object other than the finger of the human based on the output signal from the sensor 210, it is applicable that if the electronic apparatus 1 specifies that the operation detected by the sensor 200 is an operation of the object other than the finger of the human touching the detection object surface 15, the electronic apparatus 1 does not execute a part or all of the control corresponding to the operation detected by the sensor 200. The operation detected by the sensor 200 includes the operation of pressing the detection object surface 15, the slide operation performed on the detection object surface 15, and the flick operation performed on the detection object surface 15, for example.

While the electronic apparatus 1 has been described above in detail, the above description is in all aspects illustrative and not restrictive. The various examples described above can be implemented in combination as long as they are not mutually inconsistent. It is understood that numerous examples which have not been exemplified can be devised without departing from the scope of the present disclosure.

What is claimed is:

1. An electronic apparatus, comprising:
a display surface configured to be located in a surface of the electronic apparatus;
at least one processor configured to control a display of the display surface; and
a first sensor configured to detect a fingerprint of a finger touching a detection object surface being located in a position different from the display surface in the surface, and detect a first operation of a finger along the detection object surface performed on the detection object surface.

2. The electronic apparatus according to claim 1, wherein
the surface comprises a plurality of planes, and
the display surface and the detection object surface are located in an identical plane in the plurality of planes.

3. The electronic apparatus according to claim 1, wherein
the at least one processor changes a display of the display surface in accordance with the first operation being detected by the first sensor.

4. The electronic apparatus according to claim 1, wherein
the at least one processor performs a fingerprint authentication based on a detected fingerprint which is a fingerprint detected by the first sensor.

5. The electronic apparatus according to claim 4, wherein
the at least one processor displays a first screen on the display surface if the fingerprint authentication has succeeded, and does not display the first screen on the display surface if the fingerprint authentication has failed.

6. The electronic apparatus according to claim 5, wherein
the at least one processor performs the fingerprint authentication based on the detected fingerprint in a case where the display surface is in a non-display state, displays the first screen on the display surface if the fingerprint authentication has succeeded, and does not display the first screen on the display surface if the fingerprint authentication has failed.

7. The electronic apparatus according to claim 5, further comprising
a second sensor configured to detect a second operation performed on the display surface, wherein
the first screen comprises a plurality of first icons for instructing the electronic apparatus to execute an application program, and
regarding each of the plurality of first icons being displayed on the display surface, if the second sensor detects the second operation performed on the first icon, the at least one processor executes an application program corresponding to the first icon.

8. The electronic apparatus according to claim 5, wherein
the first screen comprises a plurality of first icons for instructing the electronic apparatus to execute an application program, and
if the display surface displays the first screen, the at least one processor selects a first icon to be processed from the plurality of first icons in accordance with a direction of the first operation on the detection object surface being detected by the first sensor, and executes an application program in accordance with the first icon to be processed which has been selected.

9. The electronic apparatus according to claim 8, wherein
the at least one processor
performs the fingerprint authentication when a second operation of a finger is performed on the detection object surface, displays the first screen on the display surface if the fingerprint authentication has succeeded, and does not display the first screen on the display surface if the fingerprint authentication has failed, and
perform is the fingerprint authentication when a third operation of a finger different from the second operation is performed on the detection object surface, displays a second screen which is different from the first screen on the display surface if the fingerprint authentication has succeeded, and does not display the second screen on the display surface if the fingerprint authentication has failed.

10. The electronic apparatus according to claim 9, further comprising
a second sensor configured to detect a pressing force of a finger on the detection object surface, wherein
the at least one processor determines whether or not the second and third operations have been performed on the detection object surface based on the pressing force detected by the second sensor.

11. The electronic apparatus according to claim 8, wherein
in a case where the display surface displays the first screen in accordance with a success of the fingerprint authentication, the at least one processor clears the first screen on the display surface if the first sensor does not detect the first operation performed on the detection object surface but detects a finger taking off from the detection object surface.

12. The electronic apparatus according to claim 9, wherein
in the case where the display surface displays the first screen in accordance with a success of the fingerprint authentication, the at least one processor clears the first screen and displays the second screen on the display surface if the first sensor does not detect the first operation performed on the detection object surface but detects a finger taking off from the detection object surface.

13. The electronic apparatus according to claim 12, wherein
in the case where the display surface displays the first screen in accordance with a success of the fingerprint authentication, the at least one processor displays the first screen which is semi-transparent on the display surface to have an overlap with the second screen.

14. The electronic apparatus according to claim 1, wherein
the at least one processor sets the display surface to a non-display state in accordance with the first operation being detected by the first sensor in a case where the display surface is in a display state.

15. The electronic apparatus according to claim 14, wherein
the at least one processor displays a third screen on the display surface so that the third screen gradually appears in accordance with a movement of a finger detected when the first sensor detects the first operation, and subsequently sets the display surface to a non-display state.

16. The electronic apparatus according to claim 15, wherein
the third screen is a black screen.

17. The electronic apparatus according to claim 15, wherein
the third screen is a semi-transparent screen, and
the at least one processor displays the semi-transparent screen on the display surface so that the semi-transparent screen gradually appears in accordance with a movement of a finger detected when the first sensor detects the first operation in a state where the display surface displays a fourth screen and the semi-transparent screen has an overlap with the fourth screen, and subsequently sets the display surface to a non-display state.

18. The electronic apparatus according to claim 14, wherein
the at least one processor gradually clears a display on the display surface in accordance with a movement of a finger detected when the first sensor detects the first operation to set the display surface to a non-display state.

19. The electronic apparatus according to claim 1, wherein
the at least one processor sets the display surface to a display state in accordance with the first operation being detected by the first sensor in a case where the display surface is in a non-display state.

20. An electronic apparatus comprising a plurality of planes in a surface, comprising:
a display surface located in one of the plurality of planes; and
a sensor configured to detect an operation of a finger along a detection object surface performed on the detection object surface, the detection object surface located in a position different from the display surface in the one of the plurality of planes.
